(19) United States
(12) Patent Application Publication
(10) Pub. No.: US 2021/0315168 A1
(43) Pub. Date: Oct. 14, 2021

(54) A LIGHT DIRECTING PLATFORM FOR A CULTIVAR GROWING ENVIRONMENT

(71) Applicant: Opti-Harvest, Inc., Los Angeles, CA (US)

(72) Inventors: Jodd READICK, New York, NY (US); Nicholas BOOTH, Covina, CA (US); Jonathan DESTLER, Los Angeles, CA (US); Yosepha SHAHAK RAVID, Visalia, CA (US); Daniel L. FARKAS, Los Angeles, CA (US); Nadav RAVID, Visalia, CA (US)

(21) Appl. No.: 17/287,594

(22) PCT Filed: Oct. 23, 2019
(86) PCT No.: PCT/US2019/057727

§ 371 Date: Apr. 22, 2021

Related U.S. Application Data
(60) Provisional application No. 62/749,858, filed on Oct. 24, 2018.

(51) Int. Cl. A01G 9/24; A01G 7/04; A01B 79/00; G06N 20/00

(52) U.S. Cl. CPC A01G 9/243; A01G 9/249; G06N 20/00; A01B 79/005; A01G 7/045

(57) ABSTRACT

A light delivery system that uses a reflective surface or machine employing Internet-of-Things and Artificial Intelligence, as well as manual processes and systems to create a moveable or static light field whose purpose is to increase or optimize the efficiency of cultivar (agricultural) growth by optimizing the appropriate spectrum for specific growing conditions.

### CROSS-REFERENCE

This application claims the benefit of U.S. Provisional Application No. 62/749,858, filed Oct. 24, 2018, which is hereby incorporated by reference in its entirety herein.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BACKGROUND OF THE INVENTION

Reflectors are sometimes used to direct sunlight toward plants to improve the amount of light a plant receives during the course of the day. Existing static reflectors must be pointed and angled in the “correct” direction to ensure as much light collection as possible during the course of the day and/or growing season, often manually attempting to account for seasonal variations of the position of the sun relative to the plant(s).

This invention generally relates to a light directing platform to improve the amount of light a cultivar receives during the course of the day and/or growing season.

### SUMMARY OF THE INVENTION

A light delivery system uses a reflective surface or machine employing Internet-of-Things and Artificial Intelligence, as well as manual processes and systems to create a moveable or static light field whose purpose is to increase or optimize the efficiency of cultivar (agricultural) growth by optimizing the appropriate spectrum for specific growing conditions.

By way of using an expert system and incorporating an artificial intelligence (AI) or machine learning algorithm, or alternatively direct control of the reflector, the system monitors, controls and ultimately optimizes detailed light characteristics and other variables to increase and optimize yield of specific cultivars.

At a minimum, the system comprises: a light Reflector subsystem, at least one Internet of Things (IoT) sensor, a radio, a wired system or comparable communication subsystem, a crop yield measurement subsystem, a processor, a memory and a machine learning algorithm.

Provided herein is a light directing platform for adjusting one or more light conditions in a cultivar growing environment, the platform comprising: at least one IoT sensor configured to sense and/or measure sensed data corresponding to at least one of a cultivar parameter and a growth condition; and a processor configured to provide an application comprising: an optimization module for determining a reflection modification command based at least on the sensed data; and a modification module for transmitting the reflection modification command to a communication device configured to receive the reflection modification command; and a reflector system comprising: the communication device configured to receive the reflection modification command; a reflective surface configured to reflect light to the cultivar growing environment; and a reflection modification device configured to modify a reflective property of the reflective surface based at least on the reflection modification command, to adjust the one or more light conditions in the cultivar growing environment.

In some embodiments, the reflective property comprises at least one of a light direction, a light wavelength range, a light intensity, or a light concentration. In some embodiments, the reflection modification device comprises at least one of a motor, a pulley, a gear, a bearing, a shaft, a liquid crystal, a memory metal, a shape-memory polymer, or an adjustable light filter. In some embodiments, the reflection modification device is positioned manually. In some embodiments, the processor is positioned in a remote location from that of the light directing platform. In some embodiments, processing is performed locally. In some embodiments, the processor is configured to communicate and transmit the reflection modification command via radio signal or via wired network. In some embodiments, the sensor(s) is/are configured to be Internet of Things (IoT) compatible. In some embodiments, the at least one sensor comprises at least one of a wind gauge, a rain gauge, a moisture gauge, a stem water potential dendrometer, a dendrometer, a light gauge, a humidity gauge, a camera, a microphone, a video camera, a chemical sensor, a pH meter, a gamma-ray sensor, an atmospheric pressure sensor, an O₂ sensor, an N₂ sensor, a CO₂ sensor, a light sensor, a fruit growth sensor, a reflectance sensor, an infrared sensor, a near-infrared sensor, a fruit density sensor or a thermometer. In some embodiments, the at least one sensor comprises an optical-only sensor node. In some embodiments, a sensor module includes at least two optical sensors (IR/Visible Light and Spectral Density). Additionally, the sensor module is configurable to sense and/or measure other environmental values such as temperature and/or humidity and/or water levels. The sensor module is connected to a common control unit to sense and/or measure similar variables at slightly different locations at the same time. The optical sensors are optionally configurable to be connected via fiber optic cable to extend the range and/or be directly positionable at the desired location and angle. Further, temperature readings are configurable to be taken at a distance using existing IR/Laser imaging techniques. In one embodiment, a common control unit is strapped to a fixed location inside or outside of a growth tube, also known as a “NuPlant” tube. This control unit is fed information by (approximately four) fiber optical cables, each measuring light parameters at different heights of the tube, on the inside, as well as external conditions on the outside of the growth tube as well. In some embodiments, the application is further configured for receiving historical data related to the cultivar growing environment from an administrator, and wherein the optimization module further determines the reflective property of the reflective surface based on the historical data. In some embodiments, the application further comprises a statistical module for receiving the historical data. In some embodiments, the growth condition comprises at least one of a wind speed, a wind direction, a rainfall quantity, a stem water potential, a light quantity, a light quality, a light intensity, a light angle, a soil moisture level, a soil condition or chemical makeup, a soil color, a pest condition, a relative humidity level, an image, a sound, a video, an atmospheric pressure, an O₂ level, an N₂ level, a CO₂ level, a chemical level, or a temperature. In some embodiments, the cultivar parameter comprises at least one of a growth speed, a plant size, a plant color, a plant shape, a plant condition, a plant height, a plant mass, a leaf diameter, a leaf color, a leaf shape, a plant stem water potential, a fruit size, a fruit color, a fruit ripeness, a fruit acidity, a fruit sugar content, a fruit antioxidant content, a fruit density, a foliage density, a stem elongation rate, a reflectance spectra, a fruit density, an acid content, a dry matter content, a root growth rate, a root biomass, a root volume, a root size, a root density, a foliage reflectance spectrum, a normalized difference vegetation index, an interior fruit temperature, an exterior fruit temperature, a foliage/leaf temperature, a visible spectrum reflectance, a red reflectance, an infrared (IR) reflectance, a near-infrared (NIR) reflectance, or a fruit load. In some embodiments, the light comprises at least one of a modifiable light, sunlight, UV light, Infrared (IR) light, an electric light, or an LED light. In some embodiments, the at least one sensor comprises a plurality of sensors for positioning about the cultivar growing environment. In some embodiments, the platform comprises a first sensor configured to sense and/or measure first sensed data corresponding to a cultivar parameter and/or a growth condition and a second sensor configured to sense and/or measure second sensed data corresponding to a growth condition. In some embodiments, the optimization module determines the reflection modification command based at least on the first sensed data and the second sensed data. In some embodiments, the at least one sensor comprises a plurality of sensors that collectively comprise an internet of things in communication with one another.

Provided herein is a computer-implemented method for adjusting one or more light conditions in a cultivar growing environment, the method comprising: a computer-implemented system comprising: a digital processing device comprising: at least one processor, an operating system configured to perform executable instructions, a memory, and a computer program including instructions executable by the digital processing device to create an application comprising: a software module comprising an algorithm for assessing sensed data to determine a reflection modification for a light-reflective surface; measuring sensed data corresponding to at least one of a cultivar parameter and a growth condition; utilizing a processor comprising an application for assessing the sensed data; determining a reflection modification command based at least on the sensed data; and modifying a reflective property of a reflective surface based at least on the reflection modification command; wherein the reflective surface is configured to reflect light to the cultivar growing environment to adjust the one or more light conditions in the cultivar growing environment.

In some embodiments of the computer-implemented method, the reflective property comprises at least one of a light direction, a light wavelength range, a light intensity, or a light concentration. In some embodiments of the computer-implemented method, the processor comprising the application for assessing the sensed data is positioned in a location remote from that of the cultivar growing environment. In some embodiments of the computer-implemented method, the sensed data is delivered in real-time. In some embodiments of the computer-implemented method, the sensed data is utilized in real-time. In some embodiments of the computer-implemented method, the reflection modification device comprises at least one of a motor, a pulley, a gear, a bearing, a shaft, a liquid crystal, a memory metal, a shape-memory polymer, or an adjustable light filter. In some embodiments of the computer-implemented method, modifying the reflective property comprises adjusting at least one of a motor, a pulley, a gear, a bearing, a shaft, a liquid crystal, a memory metal, a shape-memory polymer, or an adjustable light filter. In some embodiments of the computer-implemented method, the measurement of the sensed data incorporates the use of at least one of a wind gauge, a rain gauge, a soil moisture gauge, a stem water potential dendrometer, a dendrometer, a pH meter, a gamma-ray sensor, a light gauge, a humidity gauge, a camera, a microphone, a video camera, a chemical sensor, an atmospheric pressure sensor, an O₂ sensor, an N₂ sensor, a CO₂ sensor, a sporadic light sensor, a fruit growth sensor, a reflectance sensor, an infrared sensor, a near-infrared sensor, a fruit density sensor, or a thermometer. In some embodiments of the computer-implemented method, the method further comprises a step of transmitting the reflection modification command from the processor to a reflector system comprising the reflective surface. In some embodiments of the computer-implemented method, the transmitting of the reflection modification command from the processor to the reflector system is via radio signal. In some embodiments of the computer-implemented method, the method further comprises a step of modifying the reflective property of the reflective surface based on historical data. In some embodiments of the computer-implemented method, the application further comprises a statistical module for receiving a historical data related to the cultivar growing environment from an administrator, and wherein the optimization module further determines the reflective property of the reflective surface based on the historical data. In some embodiments of the computer-implemented method, the growth condition comprises at least one of a wind speed, a wind direction, a rainfall quantity, a light quantity, a light quality, a light intensity, a light angle, a soil moisture level, a relative humidity level, pH levels, gamma ray levels, an image, a sound, a video, an atmospheric pressure, an O₂ level, an N₂ level, a CO₂ level, a soil condition or chemical makeup, a soil color, a pest condition, a chemical level, a temperature, a soil color, a soil condition, or a pest condition. In some embodiments of the computer-implemented method, the cultivar parameter comprises at least one of a growth speed, a plant size, a leaf diameter, a plant height, a plant mass, a leaf color, a leaf shape, a plant color, a plant shape, a plant condition, a plant stem water potential, a fruit size, a fruit color, a fruit ripeness, a fruit acidity, a fruit antioxidant content, a fruit sugar content, a fruit density, a foliage density, a stem elongation rate, a reflectance spectra, a fruit density, an acid content, a dry matter content, a root growth rate, a root biomass, a root volume, a root size, a root density, a foliage reflectance spectrum, a normalized difference vegetation index, an interior fruit temperature, an exterior fruit temperature, a visible spectrum reflectance, an infrared reflectance, a near-infrared reflectance, or a fruit yield. In some embodiments of the computer-implemented method, the light comprises at least one of a modifiable sunlight, a UV light, an infrared (IR) light, an electric light, or an LED light,. In some embodiments of the computer-implemented method, the sensed data comprises data collected from a plurality of sensors positioned about the cultivar growing environment. In some embodiments of the computer-implemented method, the sensed data comprises first sensed data corresponding to a cultivar parameter and/or a growth condition and second sensed data corresponding to a growth condition.

Provided herein is a computer-implemented control system for a light directing platform for adjusting a growth condition in a cultivar growing environment, the control system comprising: at least one sensor configured to sense and/or measure sensed data corresponding to at least one of a cultivar parameter and a growth condition; a processor configured to provide an application comprising: an optimization module for determining a reflection modification command; and a modification module for transmitting the reflection modification command to a communication device configured to receive the reflection modification command; the application further comprising a machine learning algorithm for correlating at least one growth condition with at least one cultivar parameter, identifying a recommended growing condition for improving the at least one cultivar parameter and adjusting the reflection modification command corresponding to the sensed data pertaining to the at least one of the cultivar parameter and the growth condition. In some embodiments of the computer-implemented control system, the control system further comprises a reflector system incorporating the communication device configured to receive the reflection modification command and further comprising: a reflective surface configured to reflect light to the cultivar growing environment; and a reflection modification device configured to modify a reflective property of the reflective surface based at least on the reflection modification command, to adjust one or more light conditions in the cultivar growing environment, thereby adjusting the growth condition.

In some embodiments of the computer-implemented control system, the reflective property comprises at least one of a light direction, a light wavelength range, a light intensity, or a light concentration. In some embodiments of the computer-implemented control system, the reflection modification device comprises at least one of a motor, a pulley, a gear, a bearing, a shaft, a liquid crystal, a memory metal, a shape-memory polymer, or an adjustable light filter. In some embodiments of the computer-implemented control system, the processor is positioned in a remote location from that of the reflector system. In some embodiments of the computer-implemented control system, the processor is configured to transmit the reflection modification command via radio signal. In some embodiments of the computer-implemented control system, the at least one sensor comprises at least one of a wind gauge, a rain gauge, a soil moisture gauge, a stem water potential dendrometer, a dendrometer, a light gauge, a humidity gauge, a pH meter, a gamma-ray sensor, a camera, a microphone, a video camera, a chemical sensor, an atmospheric pressure sensor, an O₂ sensor, a N₂ sensor, a CO₂ sensor, a sporadic light sensor, a fruit growth sensor, a reflectance sensor, an infrared sensor, a near-infrared sensor, a fruit density sensor, or a thermometer. In some embodiments of the computer-implemented control system, the application is further configured for receiving historical data related to the cultivar growing environment from an administrator, and wherein the optimization module further determines the reflective property of the reflective surface based on the historical data. In some embodiments of the computer-implemented control system, the application further comprises a statistical module configured for receiving the historical data. In some embodiments of the computer-implemented control system, the application further comprises a statistical module configured for modifying the reflective property of the reflective surface based on historical data. In some embodiments of the computer-implemented control system, the growth condition comprises at least one of a wind speed, a wind direction, a rainfall quantity, a soil moisture level, a light intensity, a light angle, a light quality, a relative humidity level, a stem water potential level, an oxygen level, a carbon dioxide level, a nitrogen level, a chemical level, a soil color, a soil condition, a pest condition, or a temperature. In some embodiments of the computer-implemented control system, the cultivar parameter comprises at least one of a growth speed, a plant size, a leaf diameter, a plant height, a plant mass, a leaf color, a leaf shape, a plant color, a plant shape, a plant condition, a plant stem water potential, a fruit size, a fruit color, a fruit ripeness, a fruit acidity, a fruit sugar content, a fruit antioxidant content, a fruit density, a foliage density, a stem elongation rate, a reflectance spectra, a fruit density, an acid content, a dry matter content, a root growth rate, a root biomass, a root volume, a root size, a root density, a foliage reflectance spectra, a normalized difference vegetation index, an interior fruit temperature, an exterior fruit temperature, a red reflectance, an infrared reflectance, a near-infrared reflectance, or a fruit yield. In some embodiments of the computer-implemented control system, the light comprises at least one of a modifiable light, sunlight, a UV light, an IR light, an electric light, or an LED light. In some embodiments of the computer-implemented control system, the at least one sensor comprises a plurality of sensors for positioning about the cultivar growing environment. In some embodiments of the computer-implemented control system, the control system comprises a first sensor configured to sense and/or measure first sensed data corresponding to a cultivar parameter and/or a growth condition and a second sensor configured to sense and/or measure second sensed data corresponding to a growth condition. In some embodiments of the computer-implemented control system, the optimization module determines the reflection modification command based at least on the first sensed data and the second sensed data. In some embodiments of the computer-implemented control system, the at least one sensor comprises a plurality of sensors that collectively comprise an internet of things in communication with one another.

Provided herein is a computer-implemented method for adjusting one or more light conditions in a cultivar growing environment, the method comprising: a computer-implemented system comprising: a digital processing device comprising: at least one processor, an operating system configured to perform executable instructions, a memory, and a computer program including instructions executable by the digital processing device to create an application comprising: a software module comprising an algorithm for assessing sensed data to determine a reflection modification for a light-reflective surface; training a machine learning algorithm to identify a plurality of recommended environmental growing conditions for a crop growing in the cultivar growing environment by providing historic environmental growing condition data and real-time sensed data; receiving real-time sensed data from at least one of a plurality of sensors corresponding to at least one of a cultivar parameter and a growth condition; applying the trained machine learning algorithm to the real-time sensed data from the at least one of the plurality of sensors and the historic environmental growing condition data to generate instructions for adjustment of a reflective property of a reflective surface; determining a reflection modification command based at least on the real-time sensed data and transmitting said reflection modification command to a reflector system comprising the reflective surface; and modifying the reflective property of the reflective surface based at least on instructions from the reflection modification command; wherein the reflective surface is configured to reflect light to the cultivar growing environment to adjust the one or more light conditions in the cultivar growing environment.

In some embodiments of the computer-implemented method, the historic environmental growing condition data comprise one or more data sets selected from the group consisting of: a collection of sunrise/sunset times; a collection of seasonal and/or daily historical climatic information; a collection of date-based solar position information; and a collection of date-based sunlight quality information. In some embodiments of the computer-implemented method, the reflective property comprises at least one of a light direction, a light wavelength range, a light intensity, or a light concentration. In some embodiments of the computer-implemented method, the modifying of the reflective property comprises adjusting at least one of a motor, a pulley, a gear, a bearing, a shaft, a liquid crystal, a memory metal, a shape-memory polymer, or an adjustable light filter. In some embodiments of the computer-implemented method, the method further comprises a step of transmitting the reflection modification command from the processor to a reflector system comprising the reflective surface. In some embodiments of the computer-implemented method the transmitting is via radio signal. In some embodiments of the computer-implemented method a measurement of sensed data incorporates a use of at least one of a wind gauge, a rain gauge, a moisture gauge, a pH meter, a gamma-ray sensor, a light gauge, a humidity gauge, a camera, a microphone, a video camera, a chemical sensor, an atmospheric pressure sensor, an O₂ sensor, a N₂ sensor, a CO₂ sensor, a sporadic light sensor, a fruit growth sensor, a reflectance sensor, an infrared sensor, a near-infrared sensor, a fruit density sensor, or a thermometer. In some embodiments of the computer-implemented method, the method further comprising a step of modifying the reflective property of the reflective surface based on historical data. In some embodiments of the computer-implemented method, the growth condition comprises at least one of a wind speed, a wind direction, a rainfall quantity, a soil moisture level, a light intensity, a light angle, a light quality, a relative humidity level, an oxygen level, a carbon dioxide level, a nitrogen level, a chemical level, a soil color, a soil condition, a pest condition, or a temperature. In some embodiments of the computer-implemented method, the cultivar parameter comprises at least one of a growth speed, a plant size, a leaf diameter, a plant height, a plant mass, a leaf color, a leaf shape, a plant stem water potential, a plant color, a plant shape, a plant condition, a fruit size, a fruit color, a fruit ripeness, a fruit acidity, a fruit antioxidant content, a fruit sugar content, a fruit density, a foliage density, a stem elongation rate, a reflectance spectra, a fruit density, an acid content, a dry matter content, a root growth rate, a root biomass, a root volume, a root size, a root density, a foliage reflectance spectra, a normalized difference vegetation index, an interior fruit temperature, an exterior fruit temperature, a red reflectance, an infrared reflectance, a near-infrared reflectance, or a fruit yield. In some embodiments of the computer-implemented method, the light comprises at least one of a modifiable light, sunlight, a UV light, an IR light, an electric light, or an LED light. In some embodiments of the computer-implemented method, the sensed data comprise data collected from a plurality of sensors positioned about the cultivar growing environment. In some embodiments of the computer-implemented method, the sensed data comprises first sensed data corresponding to a cultivar parameter and/or a growth condition and second sensed data corresponding to a growth condition.

Provided herein is a light directing platform for adjusting one or more light conditions in a cultivar growing environment, the platform comprising: a system comprising: a processor configured to provide an application comprising: an optimization module for determining a reflection modification command based on input data; and a modification module for transmitting the reflection modification command to a communication device configured to receive the reflection modification command; and a reflector system comprising: the communication device configured to receive the reflection modification command; a reflective surface configured to reflect light to the cultivar growing environment; and a reflection modification device configured to modify a reflective property of the reflective surface based at least on the reflection modification command, to adjust the one or more light conditions in the cultivar growing environment. In some embodiments, the platform further comprising at least one sensor configured to sense and/or measure sensed data corresponding to at least one of a cultivar parameter and a growth condition. In some embodiments, the input data comprises one or more members of the group consisting of: time of day, day of year, existing and forecasted light, or temperature. In some embodiments, the reflective property comprises at least one of a light direction, a light wavelength range, a light intensity and a light concentration. In some embodiments, the reflection modification device comprises at least one of a motor, a pulley, a gear, a bearing, a shaft, a liquid crystal, a memory metal, a shape-memory polymer and an adjustable light filter. In some embodiments, the processor is positioned in a remote location from that of the light directing platform. In some embodiments, the processor is configured to transmit the reflection modification command via radio signal or wired network. In some embodiments, the sensor comprises at least one of a wind gauge, a rain gauge, a soil moisture gauge, a stem water potential dendrometer, a dendrometer, a pH meter, a gamma-ray sensor, a light gauge, a humidity gauge, a camera, a microphone, a video camera, a chemical sensor, an atmospheric pressure sensor, an O₂ sensor, a N₂ sensor, a CO₂ sensor, a sporadic light sensor, a fruit growth sensor, a reflectance sensor, an infrared sensor, a near-infrared sensor, a fruit density sensor, or a thermometer. In some embodiments, the application is further configured for receiving historical data related to the cultivar growing environment from an administrator, and wherein the optimization module further determines the reflective property of the reflective surface based on the historical data. In some embodiments, the application further comprises a statistical module configured for receiving the historical data. In some embodiments, the growth condition comprises at least one of a wind speed, a wind direction, a rainfall quantity, a soil moisture level, a light intensity, a light angle, a light quality, a relative humidity level, an oxygen level, a carbon dioxide level, a nitrogen level, a chemical level, a soil color, a soil condition, a pest condition, or a temperature. In some embodiments, the cultivar parameter comprises at least one of a growth speed, a plant size, a leaf diameter, a plant height, a plant mass, a leaf color, a leaf shape, a plant stem water potential, a plant color, a plant shape, a plant condition, a fruit size, a fruit color, a fruit ripeness, a fruit acidity, a fruit antioxidant content, a fruit sugar content, a fruit density, a foliage density, a stem elongation rate, a reflectance spectra, a fruit density, an acid content, a dry matter content, a root growth rate, a root biomass, a root volume, a root size, a root density, a foliage reflectance spectra, a normalized difference vegetation index, an interior fruit temperature, an exterior fruit temperature, a red reflectance, an infrared reflectance, a near-infrared reflectance, or a fruit yield. In some embodiments, the light comprises at least one of a modifiable light, sunlight, UV light, IR light, an electric light, or an LED light. In some embodiments, the at least one sensor comprises a plurality of sensors for positioning about the cultivar growing environment. In some embodiments, the platform comprises a first sensor configured to sense and/or measure first sensed data corresponding to a cultivar parameter and/or a growth condition and a second sensor configured to sense and/or measure second sensed data corresponding to a growth condition. In some embodiments, the optimization module determines the reflection modification command based at least on the first sensed data and the second sensed data. In some embodiments, the at least one sensor comprises a plurality of sensors that collectively comprise an internet of things in communication with one another. In some embodiments of the computer-implemented system, the processor is positioned in a location remote from the cultivar growing environment. In some embodiments of the computer-implemented system, the sensor is an IoT sensor.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 is an illustration of an exemplary light directing platform for a cultivar growing environment, per some embodiments herein;

FIG. 2 is an illustration of an exemplary algorithm for a cultivar growing environment, per some embodiments herein;

FIG. 3 is an illustration of exemplary IoT sensors considered for the platform, per some embodiments herein;

FIG. 4 is an illustration of an exemplary machine learning and/or AI algorithm for a cultivar growing environment, per some embodiments herein;

FIG. 5 shows a non-limiting example of a computing device; in this case, a device with one or more processors, memory, storage, and a network interface, per some embodiments herein;

FIG. 6 shows a non-limiting example of a web/mobile application provision system; in this case, a system providing browser-based and/or native mobile user interfaces, per some embodiments herein;

FIG. 7 shows a non-limiting example of a cloud-based web/mobile application provision system; in this case, a system comprising an elastically load balanced, auto-scaling web server and application server resources as well synchronously replicated databases, per some embodiments herein;

FIG. 8 is another illustration of an exemplary light directing platform for a cultivar growing environment, per some embodiments herein; and

FIG. 9 is another illustration of an exemplary algorithm for a cultivar growing environment, per some embodiments herein.

The foregoing and other features of the present disclosure will become apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

### DETAILED DESCRIPTION OF THE INVENTION

To date, there are surprisingly few existing commercial examples of Artificial Intelligence and the combined use of Internet-of-Things technology in agriculture. Much of the reported work relates to the use of airborne systems such as drones and copters employing computer vision, greenhouses, hydroponics and robotics. Most reports appear to come from academic papers as opposed to showing commercially deployed examples.

Provided herein are a light delivery systems and platforms comprising a reflective surface actuated by a machine-learning algorithm employing Internet-of-Things and Artificial Intelligence to create a moveable or static light field whose purpose is to increase or optimize the efficiency of cultivar (agricultural) growth by optimizing the appropriate spectrum for specific growing conditions utilizing IoT sensor technology and artificial intelligence algorithms.

### Platforms for Cultivar Growing Environments

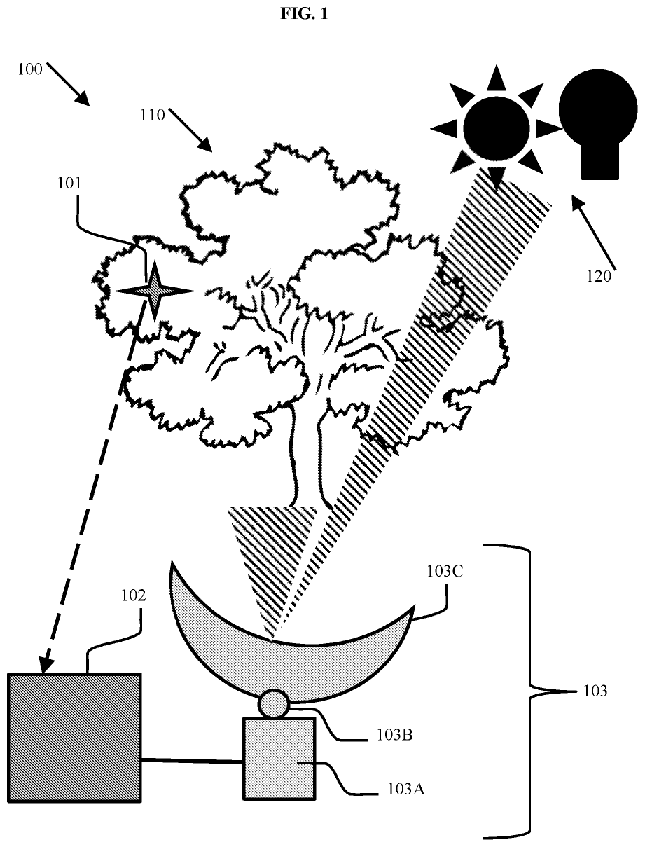

Provided herein, per FIG. 1, is a light directing platform 100 for a cultivar growing environment 110. As shown, the platform 100 comprises at least one IoT sensor 101, a processor 102, and a reflector system 103.

In some embodiments, the IoT sensor 101 is configured to sense and/or measure sensed data. In some embodiments, the at least one sensor comprises a plurality of sensors for positioning about the cultivar growing environment 110. In some embodiments, the at least one sensor 101 comprises a plurality of sensors 101 that collectively comprise an internet of things in communication with one another. In some embodiments, the sensor(s) is/are configured to be Internet of Things (IoT) compatible. In some embodiments, the at least one sensor 101 comprises at least one of a wind gauge, a rain gauge, a moisture gauge, a stem water potential dendrometer, a dendrometer, a light gauge, a humidity gauge, a camera, a microphone, a video camera, a chemical sensor, a pH meter, a gamma-ray sensor, an atmospheric pressure sensor, a sporadic light sensor, a reflectance sensor, an infrared sensor, a near-infrared sensor, a fruit density sensor, or a thermometer. In some embodiments, the dendrometer is an automated meter connected to a data logger. In some embodiments, the dendrometer is a band dendrometer or a point dendrometer. In some embodiments, the dendrometer is a trunk dendrometer or a stem dendrometer. In some embodiments, the dendrometer comprises a stem water potential dendrometer, a fruit growth sensor, or both. In some embodiments, the chemical sensor comprises an O₂ sensor, an N₂ sensor, a CO₂ sensor, or any combination thereof

In some embodiments, the at least one sensor 101 comprises an optical-only sensor node. In some embodiments, a sensor module includes at least two optical sensors (IR/Visible Light and Spectral Density). Additionally, the sensor module is configurable to sense and/or measure other environmental values such as temperature and/or humidity and/or water levels. The sensor module is connected to a common control unit to sense and/or measure similar variables at slightly different locations at the same time. The optical sensors are optionally configurable to be connected via fiber optic cable to extend the range and/or be directly positionable at the desired location and angle. Further, temperature readings are configurable to be taken at a distance using existing IR/Laser imaging techniques.

In some embodiments, the platform 100 comprises a first sensor 101 configured to sense and/or measure first sensed data corresponding to a cultivar parameter and/or a growth condition and a second sensor 101 configured to sense and/or measure second sensed data corresponding to a growth condition. In some embodiments, the sensed data corresponds to at least one of a cultivar parameter and a growth condition. In some embodiments, the growth condition comprises at least one of a wind speed, a wind direction, a rainfall quantity, a stem water potential, a light quantity, a light quality, a light intensity, a light angle, a soil moisture level, a soil condition or chemical makeup, a soil color, a pest condition, a relative humidity level, an image, a sound, a video, an atmospheric pressure, an O₂ level, an N₂ level, a CO₂ level, or a chemical level and a temperature. In some embodiments, the cultivar parameter comprises at least one of a growth speed, a plant size, a plant color, a plant shape, a plant condition, a plant height, a plant mass, a leaf diameter, a leaf color, a leaf shape, a plant stem water potential, a fruit size, a fruit color, a fruit ripeness, a fruit acidity, a fruit sugar content, a fruit antioxidant content, a fruit density, a foliage density, a stem elongation rate, a reflectance spectra, a fruit density, an acid content, a dry matter content, a root growth rate, a root biomass, a root volume, a root size, a root density, a foliage reflectance spectra, a normalized difference vegetation index (NDVI), an interior fruit temperature, an exterior fruit temperature, a visible light reflectance, a red reflectance (rRed), an infrared reflectance, a mid-infrared reflectance, a near-infrared reflectance (rNIR), or a fruit yield. In some embodiments, the NDVI is calculated as (rNIR−rRed)/(rNIR+rRed). In some embodiments, the NDVI is a graphical indicator for remote sensing analysis of vegetation based on the frequencies of light absorbed by the plant. In some embodiments, the reflectance is measured during illumination of the foliage or fruit with visible light. In some embodiments, the rRed is measured during red illumination of the foliage or fruit. In some embodiments, the infrared reflectance is measured during infrared illumination of the foliage or fruit. In some embodiments, the NDVI is a graphical indicator for remote sensing analysis of vegetation. In some embodiments, the rNIR is measured during near infrared illumination of the foliage or fruit.

In some embodiments, rebooting the sensors 101 due to system failures requires battery removal from each of the plurality of sensors 101. As the sensors 101 are often remotely located within the cultivar growing environment 110, such battery removal is time intensive. As such, in some embodiments, each sensor 101 is programmed with a reboot procedure based on a communication lapse or failure. In one example, the reboot procedure comprises restarting each sensor 101 after a communication lapse of two hours. In some embodiments, the reboot procedure comprises restarting each sensor 101 every 15 minutes after a communication lapse of two hours. In some embodiments, the reboot procedure comprises restarting each sensor 101 every hour after a communication lapse of four hours. In some embodiments, the reboot procedure comprises restarting each sensor 101 every two hours after a communication lapse of eight hours. In some embodiments, the reboot procedure comprises restarting each sensor 101 every day after a communication lapse of 24 hours.

In some embodiments, the processor 102 is configured to provide an application comprising: an optimization module and a modification module. In some embodiments, the optimization module determines a reflection modification command. In some embodiments, the optimization module determines a reflection modification command based at least on the sensed data. In some embodiments, the modification module transmits the reflection modification command to a communication device 103A. In some embodiments, the processor 102 is positioned in a remote location from that of the light directing platform 100. In some embodiments, processing is performed locally. In some embodiments, the processor 102 is configured to communicate and transmit the reflection modification command via radio signal or via wired network. In some embodiments, the optimization module determines the reflection modification command based at least on the first sensed data and the second sensed data. In some embodiments, the application is further configured for receiving historical data related to the cultivar growing environment 110 from an administrator, and wherein the optimization module further determines the reflective property of the reflective surface 103C based on the historical data. In some embodiments, the application further comprises a statistical module for receiving the historical data.

In some embodiments, the reflector system 103 comprises the communication device 103A, a reflective surface 103C, and a reflection modification device 103B. In some embodiments, the communication device 103A is configured to receive the reflection modification command. In some embodiments, the reflective surface 103C is configured to reflect light 120 to the cultivar growing environment 110. In some embodiments, the light 120 is emitted by the sun. In some embodiments, the light 120 is emitted by a light bulb, a light tube, or any other electric or chemical light source. In some embodiments, the light comprises at least one of a modifiable light, sunlight, UV light, Infrared (IR) light, an electric light, or an LED light. In some embodiments, the reflection modification device 103B is configured to modify a reflective property of the reflective surface 103C. In some embodiments, the reflection modification device 103B is configured to modify a reflective property of the reflective surface 103C based at least on the reflection modification command. In some embodiments, the reflection modification device 103B adjust the one or more light 120 conditions in the cultivar growing environment 110. In some embodiments, the reflective property comprises at least one of a light direction, a light wavelength range, a light intensity, or a light concentration. In some embodiments, the reflection modification device 103B comprises at least one of a motor, a pulley, a gear, a bearing, a shaft, a liquid crystal, a memory metal, a shape-memory polymer, or an adjustable light filter. In some embodiments, the reflection modification device 103B is positioned manually.

In one embodiment, the platform 100 further comprises a common control unit strapped to a fixed location inside or outside of a growth tube, also known as a “NuPlant” tube. This control unit is fed information by (approximately four) fiber optical cables, each measuring light parameters at different heights of the tube, on the inside, as well as external conditions on the outside of the growth tube as well.

Further provided herein is a light directing platform 100 for adjusting one or more light 120 conditions in a cultivar growing environment 110, the platform 100 comprising a system comprising: at least one IoT sensor 101 configured to sense and/or measure sensed data corresponding to at least one of a cultivar parameter and a growth condition; and a processor 102 configured to provide an application comprising: an optimization module for determining a reflection modification command based at least on the sensed data; and a modification module for transmitting the reflection modification command to a communication device 103A configured to receive the reflection modification command; and a reflector system 103 comprising: the communication device 103A configured to receive the reflection modification command; a reflective surface 103C configured to reflect light 120 to the cultivar growing environment 110; and a reflection modification device 103B configured to modify a reflective property of the reflective surface 103C based at least on the reflection modification command, to adjust the one or more light 120 conditions in the cultivar growing environment 110.

In some embodiments, the processor 102 is configured to provide an application comprising: an optimization module and a modification module. In some embodiments, the optimization module determines a reflection modification command. In some embodiments, the optimization module determines a reflection modification command based at least on the sensed data. In some embodiments, the modification module transmits the reflection modification command to a communication device 103A. In some embodiments, the processor 102 is positioned in a remote location from that of the light directing platform 100. In some embodiments, processing is performed locally. In some embodiments, the processor 102 is configured to communicate and transmit the reflection modification command via radio signal or via wired network. In some embodiments, the optimization module determines the reflection modification command based at least on the first sensed data and the second sensed data. In some embodiments, the application is further configured for receiving historical data related to the cultivar growing environment 110 from an administrator, and wherein the optimization module further determines the reflective property of the reflective surface 103C based on the historical data. In some embodiments, the application further comprises a statistical module for receiving the historical data.

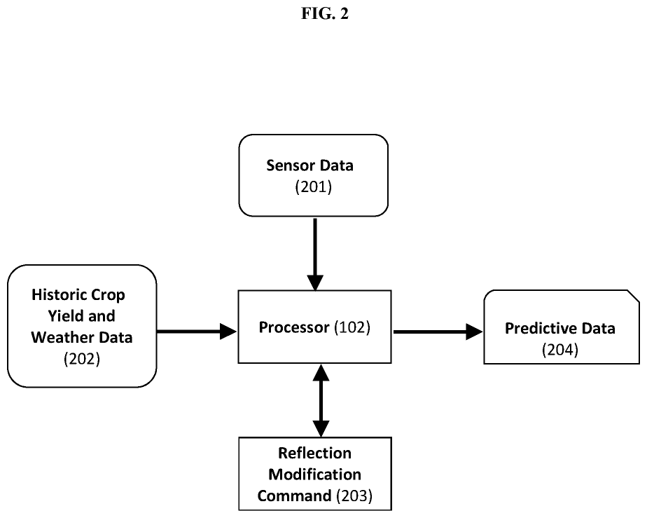

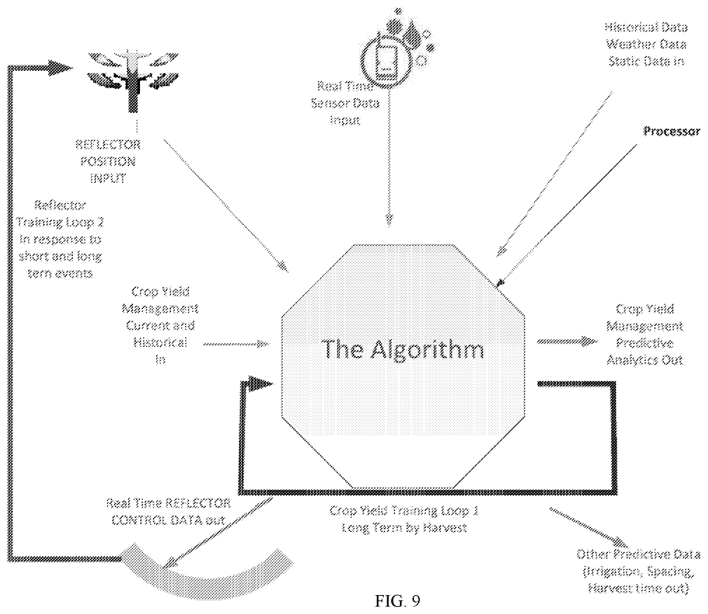

In some embodiments, per FIGS. 2 and 9, the processor 102 receives a historic crop yield and weather data 202 and the sensor data 201. In some embodiments, the processor 102 then sends a reflection modification command 203 to the reflector system based on the historic crop yield and weather data 202 and the sensor data 201. In some embodiments, the processor 102 further receives a reflection modification position from the reflector system. Finally, in some embodiments, the processor 102 further transmits a predictive data 204 based on the historic crop yield and weather data 202 and the sensor data 201.

Per FIG. 9, the algorithm within the processor receives a crop yield management current and historical data, a reflector position input, a real-time sensor data input, a historical data, a weather data, and a static data, and transmits a real time reflector control data, and other predictive data including irrigation, crop spacing and harvesting times. In some embodiments, the algorithm analyses the inputs to predict the optimal optical characteristics of the reflector. In response to short and long term changes, the algorithm instructs the Reflector to change its optical characteristics for the learnable goal of increasing cultivar yield. In some embodiments, the algorithm comprises a Crop Yield Training Loop land a Reflector Training Loop 2.

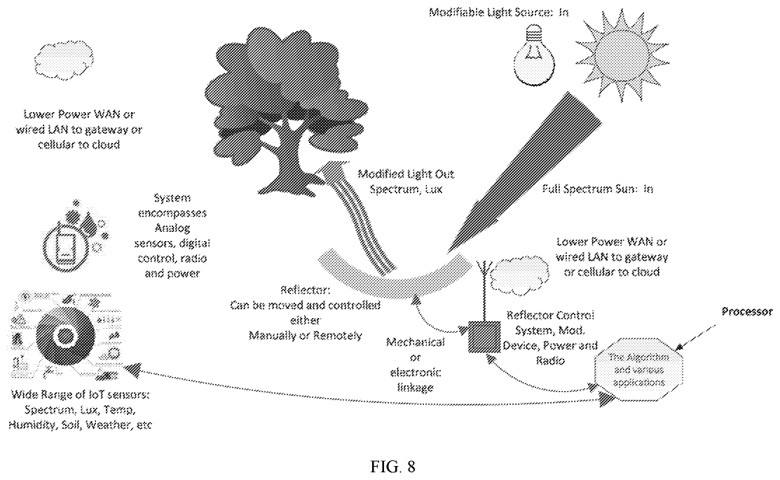

Further provided herein, per FIG. 8, is a light directing platform having an IoT sensor, a digital control, a radio, a power component, a lower power Wide Area Network (WAN) or a Local Area Network (LAN) to a gateway or cellular cloud, a reflector that can be manually moved or controlled remotely that is coupled to a mechanical or electronic linkage. In some embodiments, the reflector control system is controlled by a processor with a memory for executing machine learning and/or AI algorithms, or human-directed instructions, a communication sub-system capable of receiving/transmitting instructions and data capable of being transmitted via a WAN and stored in the cloud, and a battery. In some embodiments, the wide range of Internet-of-things sensors comprise Spectrum, lux, temperature, humidity, soil and weather sensors.

### Light Reflectors

The present disclosure provides a light delivery system that uses a reflective surface and/or a machine to create a moveable or static light field for increasing the efficiency of cultivar (agricultural) growth by optimizing the light conditions thereby adjusting growing conditions in the growing environment. Such light conditions include, for example, light quality (such as spectral quality), light intensity or concentration, or adjusting temperature or humidity conditions, or any combination thereof

In some embodiments, through direct or machine operated control of the reflector, the systems provided herein monitor, control, and adjust detailed light characteristics and other variables to increase and optimize yield of specific cultivars.

In some embodiments, the light reflector subsystem are manually moved, or driven by electro-mechanical apparatus (e.g.: motors, pulleys, etc.) under automated control. Optimally, in one preferred embodiment, the reflection generated by the reflector in the light reflector subsystem would be controlled by electronically changeable polymers (such as liquid crystals or shape-memory polymers), tri-layer sheets, or shape shifting designs.

In some embodiments, the reflector system is configured to receive a reflection modification command to adjust a reflective property of its reflective surface based on inputted data, which include one or more of: time of day, day of year, existing and forecasted light or temperature, Lux levels, etc. Lux can be expressed in other units of light (e.g.: PPFD, micro-Einstein's) Lux can refer to a summarized value of total light (such as visible or Infra-Red light) or Lux at a specific wavelength range such as red (640-680 nm).

In some embodiments, the reflector system is configured to receive a reflection modification command to adjust its reflective property at specific times of the day for specific intervals (continuous, pulsed); (e.g.: 12:00-1:00 PM, Pulse 80% on 20% off every 15 min); or to adjust reflected Lux levels (i.e.: Intensity) of various bands of light to either transmit or block. As an example, in some embodiments, adjusted reflected Lux levels are: blue (430-450 nm), min desired 5,000 Lux, max desired 20,000 Lux; from 8 am to 4 pm; red (640-680 nm), min 20,000 Lux; at any time, and/or green (495-570 nm), max 1,000 Lux, at any time.

Further, in some embodiments, the reflector system is configured to receive a reflection modification command to adjust a reflective property such as: angular width and dimensions of the field of reflected light; and/or physical location of the center of the field of reflected light; (which has the additional advantage of compensating for the placement of the reflector system).

In some embodiments, based on a combination of human judgment and/or algorithm control, the light reflector system adjusts, improves or optimize light for one or more cultivar (e.g. Sumo oranges vs. wine grapes) and be able to change its optical characteristics in response to a range of conditions such as static (e.g. physical location, plant cultivar), predictable dynamic (e.g. sunrise and sunset time), uncontrollable variable dynamic (e.g. weather), controllable or changeable dynamic: (e.g. harvest time, pruning schedules, irrigation schedules, etc.), and day of the year/seasonality for a particular cultivar.

Existing static reflectors must be pointed and angled in a desired direction to ensure as much light collection as possible during the course of the day/growing season. In some embodiments, the system disclosed herein changes its position, shift its shape, or undertake some other modification of a reflective property of a reflective surface in response to input data comprising signals from an algorithm, or optionally, as manually adjusted. In some embodiments, the reflective surface comprises tri-layer sheets with a central layer (hydrogels, liquid-crystal elastomers, and even more conventional polymers are used, like polystyrene) that swells or shrink as the surrounding environment changes. Further still, in some embodiments, the reflector system disclosed herein comprises a reflector having light-induced shape-memory polymers which are configured to fold/unfold into a pre-determined temporary shape and subsequently recover an original shape at ambient temperatures by remote light activation or exposure to ultraviolet light at a different wavelength. Further still, in some embodiments, the reflector system disclosed herein comprise a reflector having an origami style parabola shape which is configured to fold/unfold into a desired shape, guided by slits patterned into the top and bottom layers. Further still, in some embodiments, the reflector system disclosed herein comprise a reflector configured to close in response to adverse conditions such as rain, flood, or excessive wind. Further still, in some embodiments, the reflector system disclosed herein comprise a reflector configured to be flat packed and ‘self-assemble’ on site. This configuration would provide several potential advantages, for example being amenable to 2-D printing (which is more scalable than 3-D printing), and reduced shipping cost due to denser packaging. In some embodiments, the reflector system comprise one or more ‘perpetual motion’ sheets that undulate sinusoidally under exposure to UV. Such sheets have been demonstrated and are useful to shake dust off the system or to help with air flow in and around growing plants or cultivars. In some embodiments, systems of the present disclosure are configured to allow for adaptive optical filtering. Such filtering provide heat reduction or spectral customization (biased towards either leaf and stem growth or fruit ripening depending on the season/life stage of the cultivar). In some embodiments, systems of the present disclosure comprise a layer of photovoltaic material for providing power to drive properties laid out above, including recharging of the battery and providing spontaneous power for systems such as the processor, the various electro-mechanical apparatus (e.g.: motors, pulleys, etc.) and communication sub-system.

### Crop Yield Measurement and Management

In some embodiments, detailed data on specific cultivars, for example yield data, is collected for inputting into the system for training the AI algorithm. Yield data can comprise: location and date of harvest(s); unit quantity of cultivar per physical dimension (e.g.: 500′ row); raw color; fruit or plant size and/or weight; fruit chemistry—(e.g.: sugar, pH, acidity); and uniformity and consistency measures—(e.g.: color, size).

In some embodiments, global positioning system (GPS) data is collected regarding one or more of the plants in a cultivar growing environment. In some embodiments, the GPS data enables mapping and analysis of the cultivar growing environment. In some embodiments, the GPS data is collected by a GPS device. In some embodiments, in a cultivar growing environments lacking internet service, the GPS data is collected by capturing a photo of the cultivar growing environment and uploading the photo to the internet upon arriving at a location that has internet coverage. In some embodiments, in a cultivar growing environments lacking internet service, the GPS data is collected by capturing a photo of the cultivar growing environment and uploading exchangeable image file format (EXIF) metadata in the photo upon arriving at a location that has internet coverage. In some embodiments, the GPS data is then extracted from an EXIF metadata in the photo. In some embodiments, the EXIF metadata is captured directly without capturing an image.

### IoT Sensors

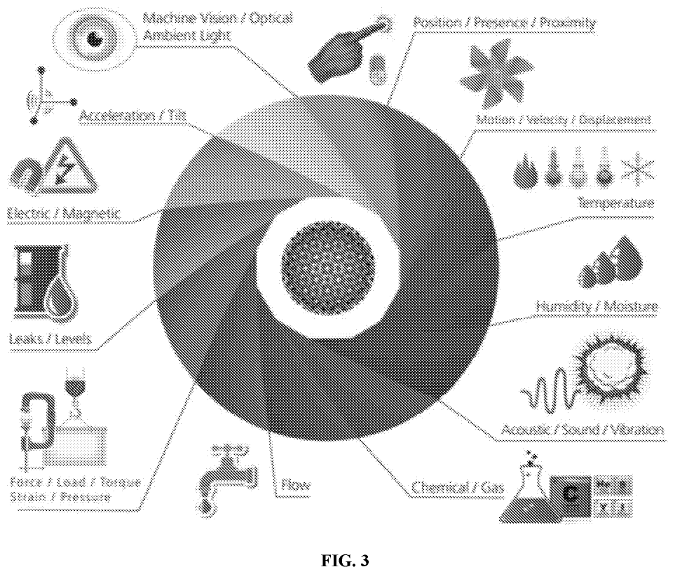

Referring now to FIG. 3, a non-limiting spectrum of wide-ranging IoT sensors considered for the platform, as noted in FIG. 1, is illustrated. As noted previously, the sensors can be applied for measuring both cultivar parameters and growth conditions; wherein the cultivar parameters can include at least one of: a growth speed, a plant size, a leaf diameter, a plant height, a plant mass, a leaf color, a leaf shape, a plant stem water potential, a plant color, a plant shape, a plant condition, a fruit size, a fruit color, a fruit ripeness, a fruit acidity, a fruit antioxidant content, a fruit sugar content, or a fruit yield.

Further, the sensors can be applied to growth conditions which can include at least one of: a wind speed, a wind direction, a rainfall quantity, a soil moisture level, a light intensity, a light angle, a light quality, a relative humidity level, an oxygen level, a carbon dioxide level, a nitrogen level, a chemical level, a soil color, a soil condition, a pest condition, or a temperature.

In some embodiments, the system collects IoT and other data from the field and merges the IoT and other data with additional data such as location, and weather forecasts. Initially, in some embodiments, the system uses manual expert informed intuition to create an expert system. In the short term, this instructs (i.e. program) the reflector how to optimize spectral light levels to create optimal cultivar growth as seen by the management system.

To date, there is limited evidence of the use of satellites using machine learning algorithms to predict weather, analyze crop sustainability and evaluate farms for the presence of diseases and pests. For example, daily weather predictions are customizable based on the needs of each client and range from hyperlocal to global. Data sources include temperature, precipitation, wind speed, and solar radiation, along with comparisons to historic values. Unfortunately, once again, there do not appear to be any case studies supporting the purported benefits or success of these satellite-based machine learning algorithms.

As time progresses over several harvest cycles, and larger amounts of more reliable data becomes available, the algorithm in some embodiments automatically optimize reflector characteristics without the need for human intervention.

Initially, some generalized rules, in their simplest form, will be applied to the algorithm, such as: when it is hot or very bright sunlight, the reflector lowers the overall reflective lux; when it is winter—the reflector adjusts to achieve a higher percentage of red light; or in the evening—the reflector adjusts to decrease the amount of blue light.

As used herein, the term “Internet of Things” or “IoT” refers to the network of physical devices, vehicles, appliances, and other items embedded with electronics, software, sensors, actuators, and connectivity which enables these things to connect and exchange data, creating opportunities for more direct integration of the physical world into computer-based systems, resulting in efficiency improvements, economic benefits, and reduced human exertions. IoT involves extending internet connectivity beyond standard devices, such as desktops, laptops, smartphones and tablets, to any range of traditionally “dumb” or non-internet-enabled physical devices and everyday objects. Embedded with technology, these devices can communicate and interact over the internet, and they can be remotely monitored and controlled. With regard to agriculture, and in particular cultivars, collecting data on such things as temperature, rainfall, relative humidity, wind speed, pest infestation and soil content, to name but a few, will be essential for efficient management of large commercial endeavors. This data can be used to automate farming techniques, take informed decisions to improve quality and quantity, minimize risk and waste, and reduce effort required to manage crops. For example, farmers can now detect which areas have been fertilized (or mistakenly missed), if the land is too dry and predict future yields. When incorporated with Artificial Intelligence (AI) or machine learning algorithms the perceived benefits are exponential.

In some embodiments, while some data elements are be manually entered, in preferred embodiments a radio-based or wired Internet of Things (IoT) collection subsystem is used to gather the needed data in real time. This is preferred when employing systems of the present disclosure under circumstances where it would be impractical to collect data by hand, for example due to: physical scope of large agricultural farm, (tens of thousands of acres); vast quantities of data, (MB or GB per day); frequency of data collection, (every 15 minutes in some cases); rate of change in conditions, (such as sudden thunderstorm); hard to collect nature of some elements, (intra-day changes in the width of a vine); remoteness of farms; (long drives to data collection points); vast expense manually collecting the data, (from thousands of points).

In some embodiments, a variety of static data and real time sensor feeds would be deployed to collect data either on demand, or a fixed schedule, such as: Lux levels at various spectral bands (Visible (R-G-B), IR, UV): at the reflector system location; at the cultivar growing environment; physical spacing data of the cultivar; cultivar and reflector physical location and compass orientation; cultivar width and stem and soil moisture levels (dendrometer based reading); actual weather: (absolute and rate of change); temperature, relative humidity, dew point, wind speed and direction, etc.; cloud cover, rainfall; exposure to water and relative humidity; heating and cooling cycles (i.e.: daily temperature variations throughout the cultivar environment); changes in the chemical composition of the atmosphere; surrounding electrical fields; pollution; pests; and soil chemistry: (e.g.: moisture, pH).

Non-IoT, historical, or input data can comprise: pruning schedule; irrigation schedule; harvest schedule; weather forecasts; and length of day—(e.g.: sunrise and sunset times).

In some embodiments, sensors would communicate via the cloud to an AI subsystem either via; (A) direct commercial cellular services; or (B) aggregated first via existing radio technologies such as LoRaWAN, LPWAN, LPN or Sigfox, (or similar) and then transmitted to the cloud via a smaller number of gateways, as in our present implementation; or (C) via a wired LAN.

### Artificial Intelligence Machine Learning System

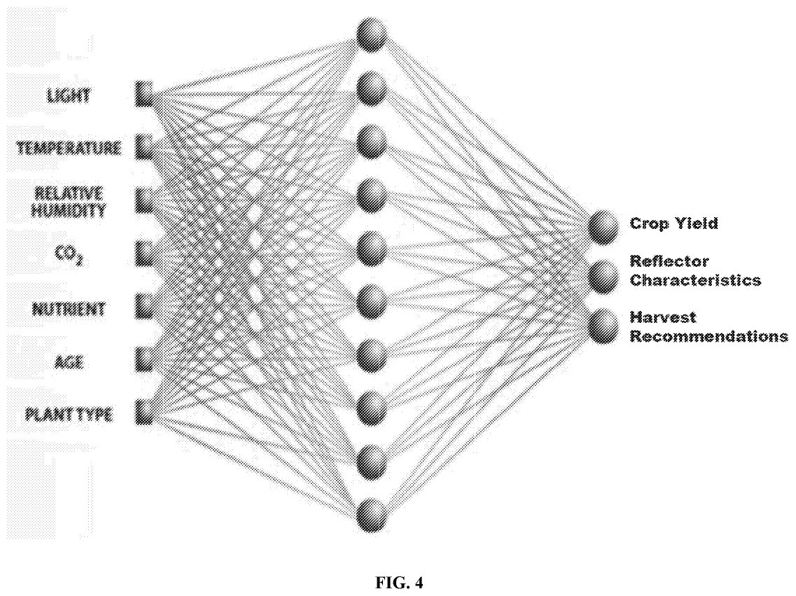

FIG. 4 shows a non-limiting illustration of the potential AI algorithm inputs, outputs and training loops for growth conditions. A similar non-limiting illustration of the potential AI algorithm similar to the inputs, outputs and training loops for cultivar parameters is envisioned based on the non-limiting list of cultivar parameters listed previously.

In some embodiments, it is advantageous to collect a wide range of short and long-term data to understand which variables contribute to cultivar growth. Historical, live and predicted input data is collected from the IoT subsystem, the reflector subsystem, the non-IoT static and dynamic sources, as well as the crop yield management subsystem.

In some embodiments, a goal of the algorithm is to analyze the above inputs to then predict the optimal optical characteristics of the reflector. In some embodiments, in response to short and long term changes, the algorithm instructs the Reflector to change its optical characteristics for the learnable goal of increasing cultivar yield. In some embodiments, this will be accomplished by using appropriate commercial AI algorithmic techniques.

To date, commercial AI algorithmic techniques leverage computer vision and deep-learning algorithms to process data captured by drones and/or software-based technology to monitor crop and soil health. Additionally, academics are racing to develop predictive machine learning models leveraging computer vision and deep-learning algorithms to process data captured by drones, smartphone cameras and/or software-based technology to monitor crop and soil health, but to date, specific case studies are not available.

In some embodiments, there will be a paucity of yield management data, as harvest times are quite slow, (ranging from perhaps four times per year, to once every two years), relative to fast moving data such as temperature or cloud cover. As a result, in some embodiments, unsupervised neural nets will ultimately be employed, as finding sufficiently large formal training sets may not be immediately feasible.

In some embodiments, the algorithm will ultimately output other recommendations to the grower such as: schedule changes in harvest time, pruning and irrigation. In some embodiments, the long-term changes in cultivar spacing will also be suggested.

As used herein, the term “Artificial Intelligence”, “(AI)” or “machine intelligence” refers to a branch of computer science that aims to create intelligent machines. It has become an essential part of the technology research associated with artificial intelligence is highly technical and specialized. The core problems of artificial intelligence include programming computers for certain traits such as: knowledge, reasoning, problem solving, perception, learning, planning and the ability to manipulate and move objects. Knowledge engineering is a core part of AI research. Machines can often act and react like humans only if they have abundant information relating to the world. Artificial intelligence must have access to objects, categories, properties and relations between all of them to implement knowledge engineering. Initiating common sense, reasoning and problem-solving power in machines is a difficult and tedious task. Machine learning is also a core part of AI. Learning without any kind of supervision requires an ability to identify patterns in streams of inputs, whereas learning with adequate supervision involves classification and numerical regressions. Classification determines the category an object belongs to and regression deals with obtaining a set of numerical input or output examples, thereby discovering functions enabling the generation of suitable outputs from respective inputs. Mathematical analysis of machine learning algorithms and their performance is a well-defined branch of theoretical computer science often referred to as computational learning theory. Machine perception deals with the capability to use sensory inputs to deduce the different aspects of the world, while computer vision is the power to analyze visual inputs with a few sub-problems such as facial, object and gesture recognition.

Referring now to FIG. 2, the application provision system comprises an artificial intelligence (AI) or machine learning algorithm, (or alternatively a direct control of the reflector), the system monitors, controls and ultimately optimizes detailed light characteristics and other variables to increase and optimize yield of specific cultivars.

The artificial intelligence (AI) or machine learning algorithm is configured to collect a wide range of short and long-term data in order to learn and understand which variables contribute to cultivar growth. Historical, live and predicted input data is collected from the IoT subsystem, the reflector subsystem, the non-IoT static and dynamic sources, as well as the crop yield management subsystem.

### Digital Processing Device

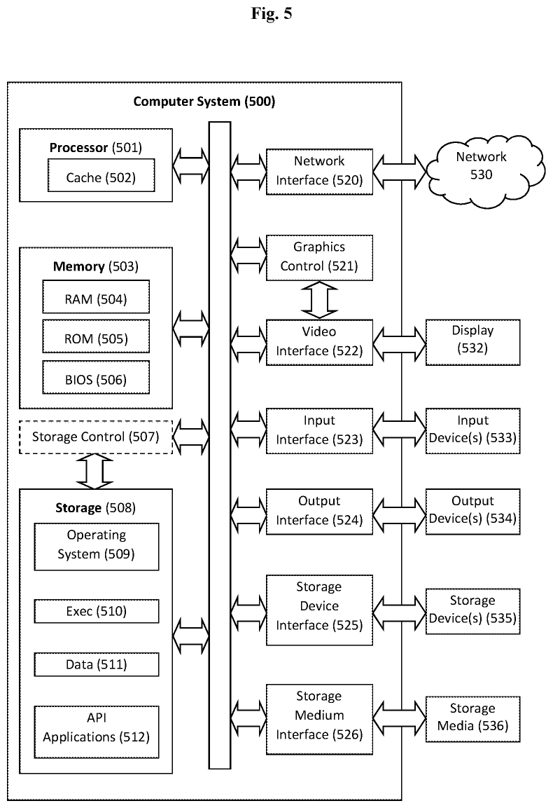

Referring to FIG. 5, a block diagram is shown depicting an exemplary machine that includes a computer system 500 (e.g., a processing or computing system) within which a set of instructions can execute for causing a device to perform or execute any one or more of the aspects and/or methodologies for static code scheduling of the present disclosure. The components in FIG. 5 are examples only and do not limit the scope of use or functionality of any hardware, software, embedded logic component, or a combination of two or more such components implementing particular embodiments.

Computer system 500 may include one or more processors 501, a memory 503, and a storage 508 that communicate with each other, and with other components, via a bus 540. The bus 540 may also link a display 532, one or more input devices 533 (which may, for example, include a keypad, a keyboard, a mouse, a stylus, etc.), one or more output devices 534, one or more storage devices 535, and various tangible storage media 536. All of these elements may interface directly or via one or more interfaces or adaptors to the bus 540. For instance, the various tangible storage media 536 can interface with the bus 540 via storage medium interface 526. Computer system 500 may have any suitable physical form, including but not limited to one or more integrated circuits (ICs), printed circuit boards (PCBs), mobile handheld devices (such as mobile telephones or PDAs), laptop or notebook computers, distributed computer systems, computing grids, or servers.

Computer system 500 includes one or more processor(s) 501 (e.g., central processing units (CPUs) or general-purpose graphics processing units (GPGPUs)) that carry out functions. Processor(s) 501 optionally contains a cache memory unit 502 for temporary local storage of instructions, data, or computer addresses. Processor(s) 501 are configured to assist in execution of computer readable instructions. Computer system 500 may provide functionality for the components depicted in FIG. 5 as a result of the processor(s) 501 executing non-transitory, processor-executable instructions embodied in one or more tangible computer-readable storage media, such as memory 503, storage 508, storage devices 535, and/or storage medium 536. The computer-readable media may store software that implements particular embodiments, and processor(s) 501 may execute the software. Memory 503 may read the software from one or more other computer-readable media (such as mass storage device(s) 535, 536) or from one or more other sources through a suitable interface, such as network interface 520. The software may cause processor(s) 501 to carry out one or more processes or one or more steps of one or more processes described or illustrated herein. Carrying out such processes or steps may include defining data structures stored in memory 503 and modifying the data structures as directed by the software.

The memory 503 may include various components (e.g., machine readable media) including, but not limited to, a random access memory component (e.g., RAM 504) (e.g., static RAM (SRAM), dynamic RAM (DRAM), ferroelectric random access memory (FRAM), phase-change random access memory (PRAM), etc.), a read-only memory component (e.g., ROM 505), and any combinations thereof. ROM 505 may act to communicate data and instructions unidirectionally to processor(s) 501, and RAM 504 may act to communicate data and instructions bidirectionally with processor(s) 501. ROM 505 and RAM 504 may include any suitable tangible computer-readable media described below. In one example, a basic input/output system 506 (BIOS), including basic routines that help to transfer information between elements within computer system 500, such as during start-up, may be stored in the memory 503.

Fixed storage 508 is connected bidirectionally to processor(s) 501, optionally through storage control unit 507. Fixed storage 508 provides additional data storage capacity and may also include any suitable tangible computer-readable media described herein. Storage 508 may be used to store operating system 509, executable(s) 510, data 511, applications 512 (application programs), and the like. Storage 508 can also include an optical disk drive, a solid-state memory device (e.g., flash-based systems), or a combination of any of the above. Information in storage 508 may, in appropriate cases, be incorporated as virtual memory in memory 503.

In one example, storage device(s) 535 may be removably interfaced with computer system 500 (e.g., via an external port connector (not shown)) via a storage device interface 525. Particularly, storage device(s) 535 and an associated machine-readable medium may provide non-volatile and/or volatile storage of machine-readable instructions, data structures, program modules, and/or other data for the computer system 500. In one example, software may reside, completely or partially, within a machine-readable medium on storage device(s) 535. In another example, software may reside, completely or partially, within processor(s) 501.

Bus 540 connects a wide variety of subsystems. Herein, reference to a bus may encompass one or more digital signal lines serving a common function, where appropriate. Bus 540 may be any of several types of bus structures including, but not limited to, a memory bus, a memory controller, a peripheral bus, a local bus, and any combinations thereof, using any of a variety of bus architectures. As an example and not by way of limitation, such architectures include an Industry Standard Architecture (ISA) bus, an Enhanced ISA (EISA) bus, a Micro Channel Architecture (MCA) bus, a Video Electronics Standards Association local bus (VLB), a Peripheral Component Interconnect (PCI) bus, a PCI-Express (PCI-X) bus, an Accelerated Graphics Port (AGP) bus, HyperTransport (HTX) bus, serial advanced technology attachment (SATA) bus, and any combinations thereof

Computer system 500 may also include an input device 533. In one example, a user of computer system 500 may enter commands and/or other information into computer system 500 via input device(s) 533. Examples of an input device(s) 533 include, but are not limited to, an alpha-numeric input device (e.g., a keyboard), a pointing device (e.g., a mouse or touchpad), a touchpad, a touch screen, a multi-touch screen, a joystick, a stylus, a gamepad, an audio input device (e.g., a microphone, a voice response system, etc.), an optical scanner, a video or still image capture device (e.g., a camera), and any combinations thereof. In some embodiments, the input device is a Kinect, Leap Motion, or the like. Input device(s) 533 may be interfaced to bus 540 via any of a variety of input interfaces 523 (e.g., input interface 523) including, but not limited to, serial, parallel, game port, USB, FIREWIRE, THUNDERBOLT, or any combination of the above.

In particular embodiments, when computer system 500 is connected to network 530, computer system 500 may communicate with other devices, specifically mobile devices and enterprise systems, distributed computing systems, cloud storage systems, cloud computing systems, and the like, connected to network 530. Communications to and from computer system 500 may be sent through network interface 520. For example, network interface 520 may receive incoming communications (such as requests or responses from other devices) in the form of one or more packets (such as Internet Protocol (IP) packets) from network 530, and computer system 500 may store the incoming communications in memory 503 for processing. Computer system 500 may similarly store outgoing communications (such as requests or responses to other devices) in the form of one or more packets in memory 503 and communicated to network 530 from network interface 520. Processor(s) 501 may access these communication packets stored in memory 503 for processing.

Examples of the network interface 520 include, but are not limited to, a network interface card, a modem, and any combination thereof. Examples of a network 530 or network segment 530 include, but are not limited to, a distributed computing system, a cloud computing system, a wide area network (WAN) (e.g., the Internet, an enterprise network), a local area network (LAN) (e.g., a network associated with an office, a building, a campus or other relatively small geographic space), a telephone network, a direct connection between two computing devices, a peer-to-peer network, and any combinations thereof. A network, such as network 530, may employ a wired and/or a wireless mode of communication. In general, any network topology may be used.

Information and data can be displayed through a display 532. Examples of a display 532 include, but are not limited to, a cathode ray tube (CRT), a liquid crystal display (LCD), a thin film transistor liquid crystal display (TFT-LCD), an organic liquid crystal display (OLED) such as a passive-matrix OLED (PMOLED) or active-matrix OLED (AMOLED) display, a plasma display, and any combinations thereof. The display 532 can interface to the processor(s) 501, memory 503, and fixed storage 508, as well as other devices, such as input device(s) 533, via the bus 540. The display 532 is linked to the bus 540 via a video interface 522, and transport of data between the display 532 and the bus 540 can be controlled via the graphics control 521. In some embodiments, the display is a video projector. In some embodiments, the display is a head-mounted display (HMD) such as a VR headset. In further embodiments, suitable VR headsets include, by way of non-limiting examples, HTC Vive, Oculus Rift, Samsung Gear VR, Microsoft HoloLens, Razer OSVR, FOVE VR, Zeiss VR One, Avegant Glyph, Freefly VR headset, and the like. In still further embodiments, the display is a combination of devices such as those disclosed herein.

In addition to a display 532, computer system 500 may include one or more other peripheral output devices 534 including, but not limited to, an audio speaker, a printer, a storage device, and any combinations thereof. Such peripheral output devices may be connected to the bus 540 via an output interface 524. Examples of an output interface 524 include, but are not limited to, a serial port, a parallel connection, a USB port, a FIREWIRE port, a THUNDERBOLT port, and any combinations thereof

In addition or as an alternative, computer system 500 may provide functionality as a result of logic hardwired or otherwise embodied in a circuit, which may operate in place of or together with software to execute one or more processes or one or more steps of one or more processes described or illustrated herein. Reference to software in this disclosure may encompass logic, and reference to logic may encompass software. Moreover, reference to a computer-readable medium may encompass a circuit (such as an IC) storing software for execution, a circuit embodying logic for execution, or both, where appropriate. The present disclosure encompasses any suitable combination of hardware, software, or both.

Those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by one or more processor(s), or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In accordance with the description herein, suitable computing devices include, by way of non-limiting examples, server computers, desktop computers, laptop computers, notebook computers, sub-notebook computers, netbook computers, netpad computers, set-top computers, media streaming devices, handheld computers, Internet appliances, mobile smartphones, tablet computers, personal digital assistants, video game consoles, and vehicles. Those of skill in the art will also recognize that select televisions, video players, and digital music players with optional computer network connectivity are suitable for use in the system described herein. Suitable tablet computers, in various embodiments, include those with booklet, slate, and convertible configurations, known to those of skill in the art.

In some embodiments, the computing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smartphone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®. Those of skill in the art will also recognize that suitable media streaming device operating systems include, by way of non-limiting examples, Apple TV®, Roku®, Boxee®, Google TV®, Google Chromecast®, Amazon Fire®, and Samsung® HomeSync®. Those of skill in the art will also recognize that suitable video game console operating systems include, by way of non-limiting examples, Sony® PS3®, Sony® PS4®, Microsoft® Xbox 360®, Microsoft Xbox One, Nintendo® Wii®, Nintendo® Wii U®, and Ouya®.

In some embodiments, the platforms, systems, media, and methods described herein include a digital processing device, or use of the same. In further embodiments, the digital processing device includes one or more hardware central processing units (CPUs) or general-purpose graphics processing units (GPGPUs) that carry out the device's functions. In still further embodiments, the digital processing device further comprises an operating system configured to perform executable instructions. In some embodiments, the digital processing device is optionally connected to a computer network. In further embodiments, the digital processing device is optionally connected to the Internet such that it accesses the World Wide Web. In still further embodiments, the digital processing device is optionally connected to a cloud computing infrastructure. In other embodiments, the digital processing device is optionally connected to an intranet. In other embodiments, the digital processing device is optionally connected to a data storage device.

In accordance with the description herein, suitable digital processing devices include, by way of non-limiting examples, server computers, desktop computers, laptop computers, notebook computers, sub-notebook computers, netbook computers, netpad computers, set-top computers, media-streaming devices, handheld computers, Internet appliances, mobile smartphones, tablet computers, personal digital assistants, video game consoles, and vehicles. Those of skill in the art will recognize that many smartphones are suitable for use in the system described herein. Those of skill in the art will also recognize that select televisions, video players, and digital music players with optional computer network connectivity are suitable for use in the system described herein. Suitable tablet computers include those with booklet, slate, and convertible configurations, known to those of skill in the art.

In some embodiments, the device includes a storage and/or memory device. The storage and/or memory device is one or more physical apparatuses used to store data or programs on a temporary or permanent basis. In some embodiments, the device is volatile memory and requires power to maintain stored information. In some embodiments, the device is non-volatile memory and retains stored information when the digital processing device is not powered. In further embodiments, the non-volatile memory comprises flash memory. In some embodiments, the non-volatile memory comprises dynamic random-access memory (DRAM). In some embodiments, the non-volatile memory comprises ferroelectric random access memory (FRAM). In some embodiments, the non-volatile memory comprises phase-change random access memory (PRAM). In other embodiments, the device is a storage device including, by way of non-limiting examples, CD-ROMs, DVDs, flash memory devices, magnetic disk drives, magnetic tapes drives, optical disk drives, and cloud computing-based storage. In further embodiments, the storage and/or memory device is a combination of devices such as those disclosed herein.

In some embodiments, the platforms, systems, media, and methods disclosed herein include one or more non-transitory computer readable storage media encoded with a program including instructions executable by the operating system of an optionally networked digital processing device. In further embodiments, a computer readable storage medium is a tangible component of a digital processing device. In still further embodiments, a computer readable storage medium is optionally removable from a digital processing device. In some embodiments, a computer readable storage medium includes, by way of non-limiting examples, CD-ROMs, DVDs, flash memory devices, solid state memory, magnetic disk drives, magnetic tape drives, optical disk drives, cloud computing systems and services, and the like. In some cases, the program and instructions are permanently, substantially permanently, semi-permanently, or non-transitorily encoded on the media.

In some embodiments, the digital processing device includes a display to send visual information to a user. In some embodiments, the display is a liquid crystal display (LCD). In further embodiments, the display is a thin film transistor liquid crystal display (TFT-LCD). In some embodiments, the display is an organic light emitting diode (OLED) display. In various further embodiments, on OLED display is a passive-matrix OLED (PMOLED) or active-matrix OLED (AMOLED) display. In some embodiments, the display is a plasma display. In other embodiments, the display is a video projector. In yet other embodiments, the display is a head-mounted display in communication with the digital processing device, such as a VR headset. In further embodiments, suitable VR headsets include, by way of non-limiting examples, HTC Vive, Oculus Rift, Samsung Gear VR, Microsoft HoloLens, Razer OSVR, FOVE VR, Zeiss VR One, Avegant Glyph, Freefly VR headset, and the like. In still further embodiments, the display is a combination of devices such as those disclosed herein.

In some embodiments, the digital processing device includes an input device to receive information from a user. In some embodiments, the input device is a keyboard. In some embodiments, the input device is a pointing device including, by way of non-limiting examples, a mouse, trackball, track pad, joystick, game controller, or stylus. In some embodiments, the input device is a touch screen or a multi-touch screen. In other embodiments, the input device is a microphone to capture voice or other sound input. In other embodiments, the input device is a video camera or other sensor to capture motion or visual input. In further embodiments, the input device is a Kinect, Leap Motion, or the like. In still further embodiments, the input device is a combination of devices such as those disclosed herein.

In a particular embodiment, an exemplary digital processing device is programmed or otherwise configured to collect, collate and process both historical and real-time data. The device can regulate various aspects of the reflector system of the present disclosure, such as, for example, the, light reflective properties, including light direction, light intensity, light wavelength range and light concentration. In this embodiment, the digital processing device includes a central processing unit (CPU, also “processor” and “computer processor” herein), which can be a single core or multi core processor, or a plurality of processors for parallel processing. The digital processing device also includes memory or memory location (e.g., random-access memory, read-only memory, flash memory), electronic storage unit (e.g., hard disk), communication interface (e.g., network adapter) for communicating with one or more other systems, and peripheral devices, such as an IoT sub-system comprising a wide range of both IoT and analog sensors, including all of those mentioned previously, digital controls, radio systems, power systems cache, other memory, data storage and/or electronic display adapters. The memory, storage unit, interface and peripheral devices are in communication with the CPU through a communication bus (solid lines), such as a motherboard. The storage unit can be a data storage unit (or data repository) for storing data. The digital processing device can be operatively coupled to a computer network (“network”) with the aid of the communication interface. The network can be the Internet, an internet and/or extranet, or an intranet and/or extranet that is in communication with the Internet. The network in some cases is a telecommunication and/or data network. The network can include one or more computer servers, which can enable distributed computing, such as cloud computing. The network, in some cases with the aid of the device, can implement a peer-to-peer network, which can enable devices coupled to the device to behave as a client or a server.

The CPU can execute a sequence of machine-readable instructions, which can be embodied in a program or software. The program or software instructions can include algorithms and various applications stored in a memory location, such as the memory. Such algorithms and various applications can include artificial intelligence (AI) logic. The instructions can be directed to the CPU, which can subsequently program or otherwise configure the CPU to implement methods of the present disclosure. Examples of operations performed by the CPU can include fetch, decode, execute, and write back. The CPU can be part of a circuit, such as an integrated circuit. One or more other components of the device can be included in the circuit. In some cases, the circuit is an application specific integrated circuit (ASIC) or a field programmable gate array (FPGA).

In some embodiments, the storage unit stores files, such as drivers, libraries and saved programs. The storage unit can store user data, e.g., user preferences and user programs. The digital processing device in some cases can include one or more additional data storage units that are external, such as located on a remote server that is in communication through an intranet or the Internet.

In some embodiments, the digital processing device communicates with one or more remote computer systems through the network. For instance, the device can communicate with a remote computer system of a user. Examples of remote computer systems include personal computers (e.g., portable PC), slate or tablet PCs (e.g., Apple® iPad, Samsung® Galaxy Tab), telephones, Smart phones (e.g., Apple® iPhone, Android-enabled device, Blackberry®), or personal digital assistants.

Methods as described herein can be implemented by way of machine (e.g., computer processor) executable code stored on an electronic storage location of the digital processing device, such as, for example, on the memory or electronic storage unit. The machine executable or machine-readable code can be provided in the form of software. During use, the code can be executed by the processor. In some cases, the code can be retrieved from the storage unit and stored on the memory for ready access by the processor. In some situations, the electronic storage unit can be precluded, and machine-executable instructions are stored on memory.

In a particular embodiment, an application provision system comprises one or more databases accessed by a relational database management system (RDBMS). Suitable RDBMSs include Firebird, MySQL, PostgreSQL, SQLite, Oracle Database, Microsoft SQL Server, IBM DB2, IBM Informix, SAP Sybase, SAP Sybase, Teradata, and the like. In this embodiment, the application provision system further comprises one or more application severs (such as Java servers, .NET servers, PHP servers, and the like) and one or more web servers (such as Apache, IIS, GWS and the like). The web server(s) optionally expose one or more web services via app application programming interfaces (APIs). Via a network, such as the Internet, the system provides browser-based and/or mobile native user interfaces.

In a particular embodiment, an application provision system alternatively has a distributed, cloud-based architecture and comprises elastically load balanced, auto-scaling web server resources and application server resources as well synchronously replicated databases.

### Computer Program

In some embodiments, the platforms, systems, media, and methods disclosed herein include at least one computer program, or use of the same. A computer program includes a sequence of instructions, executable in the digital processing device's CPU, written to perform a specified task. Computer readable instructions can be implemented as program modules, such as functions, objects, Application Programming Interfaces (APIs), data structures, and the like, that perform particular tasks or implement particular abstract data types. In light of the disclosure provided herein, those of skill in the art will recognize that a computer program can be written in various versions of various languages.

The functionality of the computer readable instructions can be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft® .NET or Ruby on Rails (RoR). In some embodiments, a web application utilizes one or more database systems including, by way of non-limiting examples, relational, non-relational, object oriented, associative, and XML database systems. In further embodiments, suitable relational database systems include, by way of non-limiting examples, Microsoft® SQL Server, mySQL™, and Oracle®. Those of skill in the art will also recognize that a web application, in various embodiments, is written in one or more versions of one or more languages. A web application can be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or eXtensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash® Actionscript, Javascript, or Silverlight®. In some embodiments, a web application is written to some extent in a server-side coding language such as Active Server Pages (ASP), ColdFusion®, Perl, Java™, JavaServer Pages (JSP), Hypertext Preprocessor (PHP), Python™, Ruby, Tcl, Smalltalk, WebDNA or Groovy. In some embodiments, a web application is written to some extent in a database query language such as Structured Query Language (SQL). In some embodiments, a web application integrates enterprise server products such as IBM® Lotus Domino®. In some embodiments, a web application includes a media player element. In various further embodiments, a media player element utilizes one or more of many suitable multimedia technologies including, by way of non-limiting examples, Adobe® Flash®, HTML 5, Apple® QuickTime®, Microsoft® Silverlight®, Java™, and Unity®.

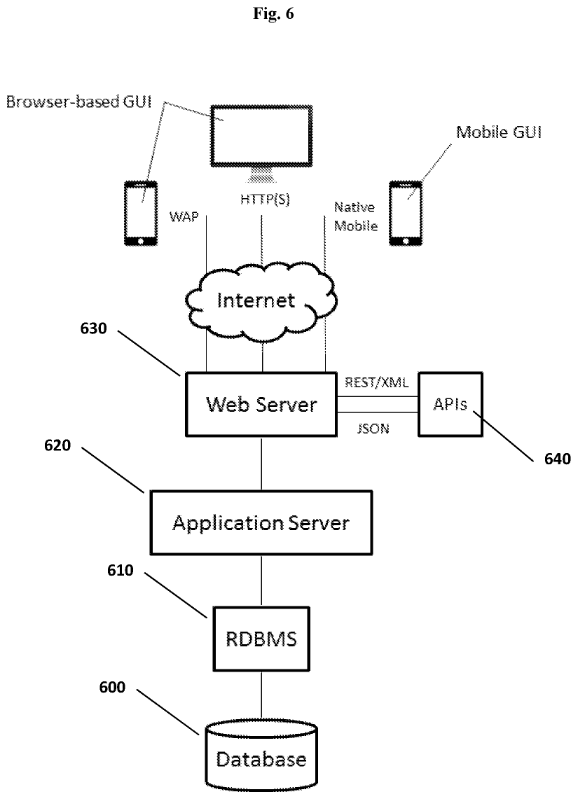

Referring to FIG. 6, in a particular embodiment, an application provision system comprises one or more databases 600 accessed by a relational database management system (RDBMS) 610. Suitable RDBMSs include Firebird, MySQL, PostgreSQL, SQLite, Oracle Database, Microsoft SQL Server, IBM DB2, IBM Informix, SAP Sybase, SAP Sybase, Teradata, and the like. In this embodiment, the application provision system further comprises one or more application severs 620 (such as Java servers, .NET servers, PHP servers, and the like) and one or more web servers 630 (such as Apache, IIS, GWS and the like). The web server(s) optionally expose one or more web services via app application programming interfaces (APIs) 640. Via a network, such as the Internet, the system provides browser-based and/or mobile native user interfaces.

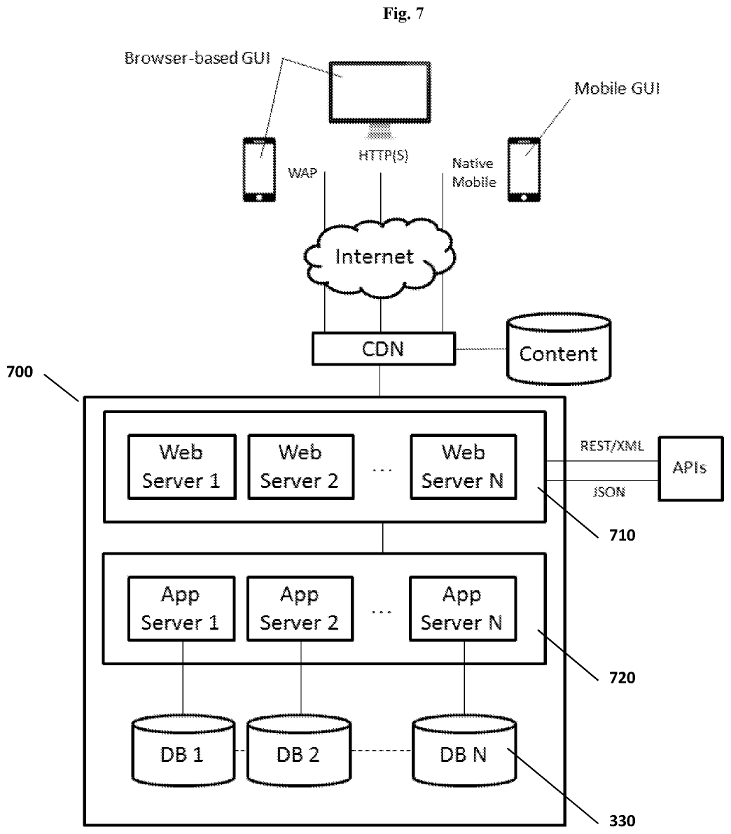

Referring to FIG. 7, in a particular embodiment, an application provision system alternatively has a distributed, cloud-based architecture 700 and comprises elastically load balanced, auto-scaling web server resources 710 and application server resources 720 as well synchronously replicated databases 730.

### Mobile Application

In some embodiments, a computer program includes a mobile application provided to a mobile digital processing device. In some embodiments, the mobile application is provided to a mobile digital processing device at the time it is manufactured. In other embodiments, the mobile application is provided to a mobile digital processing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java™, Javascript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Google® Play, Chrome WebStore, BlackBerry® App World, App Store for Palm devices, App Catalog for webOS, Windows® Marketplace for Mobile, Ovi Store for Nokia® devices, Samsung® Apps, and Nintendo® DSi Shop.

### Standalone Application

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB .NET, or combinations thereof. Compilation is often performed, at least in part, to create an executable program. In some embodiments, a computer program includes one or more executable compiled applications.

### Web Browser Plug-In

In some embodiments, the computer program includes a web browser plug-in (e.g., extension, etc.). In computing, a plug-in is one or more software components that add specific functionality to a larger software application. Makers of software applications support plug-ins to enable third-party developers to create abilities which extend an application, to support easily adding new features, and to reduce the size of an application. When supported, plug-ins enable customizing the functionality of a software application. For example, plug-ins are commonly used in web browsers to play video, generate interactivity, scan for viruses, and display particular file types. Those of skill in the art will be familiar with several web browser plug-ins including, Adobe® Flash® Player, Microsoft® Silverlight®, and Apple® QuickTime®.

In view of the disclosure provided herein, those of skill in the art will recognize that several plug-in frameworks are available that enable development of plug-ins in various programming languages, including, by way of non-limiting examples, C++, Delphi, Java™, PHP, Python™, and VB .NET, or combinations thereof

Web browsers (also called Internet browsers) are software applications, designed for use with network-connected digital processing devices, for retrieving, presenting, and traversing information resources on the World Wide Web. Suitable web browsers include, by way of non-limiting examples, Microsoft® Internet Explorer®, Mozilla® Firefox®, Google® Chrome, Apple® Safari®, Opera Software® Opera®, and KDE Konqueror. In some embodiments, the web browser is a mobile web browser. Mobile web browsers (also called micro-browsers, mini-browsers, and wireless browsers) are designed for use on mobile digital processing devices including, by way of non-limiting examples, handheld computers, tablet computers, netbook computers, subnotebook computers, smartphones, music players, personal digital assistants (PDAs), and handheld video game systems. Suitable mobile web browsers include, by way of non-limiting examples, Google Android browser, RIM BlackBerry® Browser, Apple Safari ® , Palm® Blazer, Palm® WebOS® Browser, Mozilla® Firefox® for mobile, Microsoft® Internet Explorer® Mobile, Amazon® Kindle® Basic Web, Nokia® Browser, Opera Software® Opera® Mobile, and Sony® PSP™ browser.

### Software Modules

In some embodiments, the platforms, systems, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

### Databases

In some embodiments, the platforms, systems, media, and methods disclosed herein include one or more databases, or use of the same. In view of the disclosure provided herein, those of skill in the art will recognize that many databases are suitable for storage and retrieval of sensed data corresponding to at least one of a cultivar parameter and a growth condition. In various embodiments, suitable databases include, by way of non-limiting examples, relational databases, non-relational databases, object-oriented databases, object databases, entity-relationship model databases, associative databases, and XML databases. Further non-limiting examples include SQL, PostgreSQL, MySQL, Oracle, DB2, and Sybase. In some embodiments, a database is internet-based. In further embodiments, a database is web-based. In still further embodiments, a database is cloud computing-based. In other embodiments, a database is based on one or more local computer storage devices.

### Terms and Definitions

Unless otherwise defined, all technical terms used herein have the same meaning as commonly understood by one of ordinary skill in the art to which this invention belongs.

As used herein, the singular forms “a,” “an,” and “the” include plural references unless the context clearly dictates otherwise. Any reference to “or” herein is intended to encompass “and/or” unless otherwise stated.

As used herein, the term “about” refers to an amount that is near the stated amount by about 10%, 5%, or 1%, including increments therein.

As used herein, the term “cultivar” refers to a plant variety that has been produced in cultivation by selective breeding. More generally, cultivar refers to the most basic classification category of cultivated plants in the International Code of Nomenclature for Cultivated Plants (ICNCP). Most cultivars arose in cultivation, but a few are special selections from the wild.

As used herein, the term “Lux level” or “Lux” refers to the SI derived unit (International System of Units—based on the meter, kilogram, second, ampere, kelvin, candela, and mole) of illuminance and luminous emittance, measuring luminous flux per unit area. It is equal to one lumen per square meter. In photometry, this is used as a sense and/or measure of the intensity, as perceived by the human eye, of light that hits or passes through a surface.

As used herein, the term “light spectrum” or “spectrum” refers to the visible spectrum, the range of wavelengths of electromagnetic radiation which our eyes are sensitive to. Alternatively, it can mean a plot (or chart or graph) of the intensity of light vs its wavelength (or, sometimes, its frequency).

While certain embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein can be employed in practicing the invention. It is intended that the following claims define the scope of the invention and that methods and structures within the scope of these claims and their equivalents be covered thereby.

What is claimed is:

1. A light directing platform for adjusting one or more light conditions in a cultivar growing environment, the platform comprising:
a) at least one sensor configured to sense and/or measure sensed data corresponding to at least one of a cultivar parameter or a growth condition; and
b) a processor configured to provide an application comprising:
i) an optimization module for determining a reflection modification command based at least on the sensed data; and
ii) a modification module for transmitting the reflection modification command to a communication device configured to receive the reflection modification command; and
c) a reflector system comprising:
i) the communication device configured to receive the reflection modification command;
ii) a reflective surface configured to reflect light to the cultivar growing environment; and
iii) a reflection modification device configured to modify a reflective property of the reflective surface based at least on the reflection modification command, to adjust the one or more light conditions in the cultivar growing environment.

2. The platform of claim 1, wherein the reflective property comprises at least one of a light direction, a light wavelength range, a light intensity, or a light concentration.

3. The platform of claim 1, wherein the reflection modification device comprises at least one of a motor, a pulley, a gear, a bearing, a shaft, a liquid crystal, a memory metal, a shape-memory polymer, or an adjustable light filter.

4. The platform of claim 1, wherein the processor is positioned in a remote location from that of the light directing platform.

5. The platform of claim 4, wherein the processor is configured to communicate the reflection modification command via radio signal.

6. The platform of claim 1, wherein the at least one sensor comprises at least one of a wind gauge, a rain gauge, a soil moisture gauge, a light gauge, a humidity gauge, a stem water potential dendrometer, a dendrometer, a pH meter, a gamma-ray sensor, a camera, a microphone, a video camera, a chemical sensor, an atmospheric pressure sensor, an O₂ sensor, a N₂ sensor, a CO₂ sensor, a sporadic light sensor, a fruit growth sensor, a reflectance sensor, an infrared sensor, a mid-infrared sensor, near-infrared sensor, a fruit density sensor, or a thermometer.

7. The platform of claim 1, wherein the application is further configured for receiving historical data related to the cultivar growing environment from an administrator, and wherein the optimization module further determines the reflective property of the reflective surface based on the historical data.

8. The platform of claim 7, wherein the application further comprises a statistical module configured for receiving the historical data.

9. The platform of claim 1, wherein the growth condition comprises at least one of a wind speed, a wind direction, a rainfall quantity, a soil moisture level, a light intensity, a light angle, a light quality, a relative humidity level, an oxygen level, a carbon dioxide level, a nitrogen level, a chemical level, a soil color, a soil condition, a pest condition, or a temperature.

10. The platform of claim 1, wherein the cultivar parameter comprises at least one of a growth speed, a plant size, a leaf diameter, a plant height, a plant mass, a leaf color, a leaf shape, a plant stem water potential, a plant color, a plant shape, a plant condition, a fruit size, a fruit color, a fruit ripeness, a fruit acidity, a fruit antioxidant content, a fruit sugar content, a fruit density, a foliage density, a stem elongation rate, a reflectance spectra, a fruit density, an acid content, a dry matter content, a root growth rate, a root biomass, a root volume, a root size, a root density, a foliage reflectance spectra, a normalized difference vegetation index, an interior fruit temperature, an exterior fruit temperature, a red reflectance, an infrared reflectance, mid-infrared sensor, a near-infrared reflectance, or a fruit yield.

11. The platform of claim 1, wherein the light comprises at least one of a modifiable light, sunlight, UV light, IR light, an electric light, or an LED light.

12. The platform of claim 1, wherein the at least one sensor comprises a plurality of sensors for positioning about the cultivar growing environment.

13. The platform of claim 1, wherein the platform comprises a first sensor configured to sense and/or measure first sensed data corresponding to a cultivar parameter and/or a growth condition and a second sensor configured to sense and/or measure second sensed data corresponding to a growth condition.

14. The platform of claim 13, wherein the optimization module determines the reflection modification command based at least on the first sensed data and the second sensed data.

15. The platform of claim 14, wherein the at least one sensor comprises a plurality of sensors that collectively comprise an internet of things in communication with one another.

16. A computer-implemented method for adjusting one or more light conditions in a cultivar growing environment, the method comprising:
a) measuring a sensed data corresponding to at least one of a cultivar parameter and a growth condition;
b) utilizing a processor comprising an application for assessing the sensed data;
c) determining a reflection modification command based at least on the sensed data; and
d) modifying a reflective property of a reflective surface based at least on the reflection modification command;
e) wherein the reflective surface is configured to reflect light to the cultivar growing environment to adjust the one or more light conditions in the cultivar growing environment.

17. The method of claim 16, wherein the reflective property comprises at least one of a light direction, a light wavelength range, a light intensity, or a light concentration.

18. The method of claim 16, wherein the modifying of the reflective property comprises adjusting at least one of a motor, a pulley, a gear, a bearing, a shaft, a liquid crystal, a memory metal, a shape-memory polymer, or an adjustable light filter.

19. The method of claim 16, further comprising a step of transmitting the reflection modification command from the processor to a reflector system comprising the reflective surface.

20. The method of claim 19, wherein the transmitting is via radio signal.

21. The method of claim 16, wherein measuring the sensed data incorporates a use of at least one of a wind gauge, a rain gauge, a soil moisture gauge, a light gauge, a humidity gauge, a stem water potential dendrometer, a pH meter, a gamma-ray sensor, a camera, a microphone, a video camera, a chemical sensor, an atmospheric pressure sensor, an O₂ sensor, a N₂ sensor, a CO₂ sensor, a sporadic light sensor, a fruit growth sensor, a reflectance sensor, an infrared sensor, a near-infrared sensor, mid-infrared sensor, a fruit density sensor, or a thermometer.

22. The method of claim 16, further comprising a step of modifying the reflective property of the reflective surface based on historical data.

23. The method of claim 16, wherein the growth condition comprises at least one of a wind speed, a wind direction, a rainfall quantity, a soil moisture level, a light intensity, a light angle, a light quality, a relative humidity level, a pH level, a gamma ray level, an atmospheric pressure, an oxygen level, a carbon dioxide level, a nitrogen level, a chemical level, a soil color, a soil condition or chemical make-up, a pest condition, or a temperature.

24. The method of claim 16, wherein the cultivar parameter comprises at least one of a growth speed, a plant size, a leaf diameter, a plant height, a plant mass, a leaf color, a leaf shape, a plant color, a plant shape, a plant condition, a plant stem water potential, a fruit size, a fruit color, a fruit ripeness, a fruit acidity, a fruit sugar content, a fruit antioxidant content, a fruit density, a foliage density, a stem elongation rate, a reflectance spectra, a fruit density, an acid content, a dry matter content, a root growth rate, a root biomass, a root volume, a root size, a root density, a foliage reflectance spectra, a normalized difference vegetation index, an interior fruit temperature, an exterior fruit temperature, a red reflectance, an infrared reflectance, mid-infrared sensor, a near-infrared reflectance, or a fruit yield.

25. The method of claim 16, wherein the light comprises at least one of a modifiable light, sunlight, UV light, IR light, an electric light, or an LED light.

26. The method of claim 16, wherein the sensed data comprise data collected from a plurality of sensors positioned about the cultivar growing environment.

27. The method of claim 16, wherein the sensed data comprises first sensed data corresponding to a cultivar parameter and/or a growth condition and second sensed data corresponding to a growth condition.

28. The method of claim 16, wherein the processor comprising the application for assessing the sensed data is positioned in a location remote from the cultivar growing environment.

29. The method of claim 16, wherein the reflection modification device comprises at least one of a motor, a pulley, a gear, a bearing, a shaft, a liquid crystal, a memory metal, a shape-memory polymer, or an adjustable light filter.

30. A computer-implemented control system for a light directing platform for adjusting a growth condition in a cultivar growing environment, the control system comprising:
a) at least one sensor configured to sense and/or measure sensed data corresponding to at least one of a cultivar parameter and a growth condition;
b) a processor configured to provide an application comprising:
c) an optimization module for determining a reflection modification command; and
d) a modification module for transmitting the reflection modification command to a communication device configured to receive the reflection modification command;
e) the application further comprising a machine learning algorithm for correlating at least one growth condition with at least one cultivar parameter, identifying a recommended growing condition for improving the at least one cultivar parameter and adjusting the reflection modification command corresponding to the sensed data pertaining to the at least one of the cultivar parameter and the growth condition.

31. The control system of claim 30, further comprising:
a) a reflector system incorporating the communication device configured to receive the reflection modification command and further comprising:
b) a reflective surface configured to reflect light to the cultivar growing environment; and
c) a reflection modification device configured to modify a reflective property of the reflective surface based at least on the reflection modification command, to adjust one or more light conditions in the cultivar growing environment, thereby adjusting the growth condition.

32. The control system of claim 31, wherein the reflective property comprises at least one of a light direction, a light wavelength range, a light intensity, or a light concentration.

33. The control system of claim 31, wherein the reflection modification device comprises at least one of a motor, a pulley, a gear, a bearing, a shaft, a liquid crystal, a memory metal, a shape-memory polymer, or an adjustable light filter.

34. The control system of claim 30 , wherein the processor is positioned in a remote location from that of the reflector system.

35. The control system of claim 34, wherein the processor is configured to transmit the reflection modification command via radio signal.

36. The control system of claim 30, wherein the at least one sensor comprises at least one of a wind gauge, a rain gauge, a soil moisture gauge, a stem water potential dendrometer, a light gauge, a humidity gauge, a pH meter, a gamma-ray sensor, a camera, a microphone, a video camera, a chemical sensor, an atmospheric pressure sensor, an O₂ sensor, a N₂ sensor, a CO₂ sensor, a sporadic light sensor, a fruit growth sensor, a reflectance sensor, an infrared sensor, a near-infrared sensor, mid-infrared sensor, a fruit density sensor, or a thermometer.

37. The control system of claim 30, wherein the application is further configured for receiving historical data related to the cultivar growing environment from an administrator, and wherein the optimization module further determines the reflective property of the reflective surface based on the historical data.

38. The control system of claim 37, wherein the application further comprises a statistical module configured for receiving the historical data.

39. The control system of claim 30, wherein the growth condition comprises at least one of a wind speed, a wind direction, a rainfall quantity, a soil moisture level, a light intensity, a light angle, a light quality, a relative humidity level, a stem water potential level, an oxygen level, a carbon dioxide level, a nitrogen level, a chemical level, a soil color, a soil condition, a pest condition, or a temperature.

40. The control system of claim 30, wherein the cultivar parameter comprises at least one of a growth speed, a plant size, a leaf diameter, a plant height, a plant mass, a leaf color, a leaf shape, a plant color, a plant shape, a plant condition, a plant stem water potential, a fruit size, a fruit color, a fruit ripeness, a fruit acidity, a fruit sugar content, a fruit antioxidant content, a fruit density, a foliage density, a stem elongation rate, a reflectance spectra, a fruit density, an acid content, a dry matter content, a root growth rate, a root biomass, a root volume, a root size, a root density, a foliage reflectance spectra, a normalized difference vegetation index, an interior fruit temperature, an exterior fruit temperature, a red reflectance, a mid-infrared sensor, an infrared reflectance, a near-infrared reflectance, or a fruit yield.

41. The control system of claim 30, wherein the light comprises at least one of a modifiable light, sunlight, UV light, IR light, an electric light, or an LED light.

42. The control system of claim 30, wherein the at least one sensor comprises a plurality of sensors for positioning about the cultivar growing environment.

43. The control system of claim 30, wherein the control system comprises a first sensor configured to sense and/or measure first sensed data corresponding to a cultivar parameter and/or a growth condition and a second sensor configured to sense and/or measure second sensed data corresponding to a growth condition.

44. The control system of claim 43, wherein the optimization module determines the reflection modification command based at least on the first sensed data and the second sensed data.

45. The control system of claim 44, the at least one sensor comprises a plurality of sensors that collectively comprise an internet of things in communication with one another

46. A computer-implemented method for adjusting one or more light conditions in a cultivar growing environment, the method comprising:
a) training a machine learning algorithm to identify a plurality of recommended environmental growing conditions for a crop growing in the cultivar growing environment by providing historic environmental growing condition data and real-time sensed data;
b) receiving sensed data from at least one of a plurality of sensors corresponding to at least one of a cultivar parameter and a growth condition;
c) applying the trained machine learning algorithm to the sensed data from the at least one of the plurality of sensors and the historic environmental growing condition data to generate instructions for adjustment of a reflective property of a reflective surface;
d) determining a reflection modification command based at least on the real-time sensed data and transmitting said reflection modification command to a reflector system comprising the reflective surface; and
e) modifying the reflective property of the reflective surface based at least on the instructions from the reflection modification command;
wherein the reflective surface is configured to reflect light to the cultivar growing environment to adjust the one or more light conditions in the cultivar growing environment.

47. The method of claim 46, wherein the historic environmental growing condition data comprise one or more data sets selected from the group consisting of: a collection of sunrise/sunset times, a collection of seasonal and/or daily historical climatic information, a collection of date-based solar position information, or a collection of date-based sunlight quality information.

48. The method of claim 46, wherein the reflective property comprises at least one of a light direction, a light wavelength range, a light intensity, or a light concentration.

49. The method of claim 46, wherein the modifying of the reflective property comprises adjusting at least one of a motor, a pulley, a gear, a bearing, a shaft, a liquid crystal, a memory metal, a shape-memory polymer, or an adjustable light filter.

50. The method of claim 46, further comprising a step of transmitting the reflection modification command from the processor to a reflector system comprising the reflective surface.

51. The method of claim 50, wherein the transmitting is via radio signal.

52. The method of claim 46, wherein a measurement of sensed data incorporates a use of at least one of a wind gauge, a rain gauge, a moisture gauge, a pH meter, a gamma-ray sensor, a light gauge, a humidity gauge, a camera, a microphone, a video camera, a chemical sensor, an atmospheric pressure sensor, an O₂ sensor, a N₂ sensor, a CO₂ sensor, a sporadic light sensor, a fruit growth sensor, a reflectance sensor, a mid-infrared sensor, an infrared sensor, a near-infrared sensor, a fruit density sensor, or a thermometer.

53. The method of claim 46, further comprising a step of modifying the reflective property of the reflective surface based on historical data.

54. The method of claim 46, wherein the growth condition comprises at least one of a wind speed, a wind direction, a rainfall quantity, a soil moisture level, a light intensity, a light angle, a light quality, a relative humidity level, an oxygen level, a carbon dioxide level, a nitrogen level, a chemical level, a soil color, a soil condition, a pest condition, or a temperature.

55. The method of claim 46, wherein the cultivar parameter comprises at least one of a growth speed, a plant size, a leaf diameter, a plant height, a plant mass, a leaf color, a leaf shape, a plant stem water potential, a plant color, a plant shape, a plant condition, a fruit size, a fruit color, a fruit ripeness, a fruit acidity, a fruit antioxidant content, a fruit sugar content, a fruit density, a foliage density, a stem elongation rate, a reflectance spectra, a fruit density, an acid content, a dry matter content, a root growth rate, a root biomass, a root volume, a root size, a root density, a foliage reflectance spectra, a normalized difference vegetation index, an interior fruit temperature, an exterior fruit temperature, a red reflectance, a mid-infrared reflectance, an infrared reflectance, a near-infrared reflectance, or a fruit yield.

56. The method of claim 46, wherein the light comprises at least one of a modifiable light, sunlight, UV light, IR light, an electric light, or an LED light.

57. The method of claim 46, wherein the sensed data comprise data collected from a plurality of sensors positioned about the cultivar growing environment.

58. The method of claim 46, wherein the sensed data comprises first sensed data corresponding to a cultivar parameter and/or a growth condition and second sensed data corresponding to a growth condition.

59. A light directing platform for adjusting one or more light conditions in a cultivar growing environment, the platform comprising:
a) a processor configured to provide an application comprising:
i) an optimization module for determining a reflection modification command based on input data; and
ii) a modification module for transmitting the reflection modification command to a communication device configured to receive the reflection modification command; and
b) a reflector system comprising:
i) the communication device configured to receive the reflection modification command;
ii) a reflective surface configured to reflect light to the cultivar growing environment; and
iii) a reflection modification device configured to modify a reflective property of the reflective surface based at least on the reflection modification command, to adjust the one or more light conditions in the cultivar growing environment.

60. The platform of claim 59, further comprising at least one sensor configured to sense and/or measure sensed data corresponding to at least one of a cultivar parameter and a growth condition.

61. The platform of claim 59, wherein the input data comprises one or more members of the group consisting of: time of day, day of year, existing and forecasted light, and temperature.

62. The platform of claim 59, wherein the reflective property comprises at least one of a light direction, a light wavelength range, a light intensity, or a light concentration.

63. The platform of claim 59, wherein the reflection modification device comprises at least one of a motor, a pulley, a gear, a bearing, a shaft, a liquid crystal, a memory metal, a shape-memory polymer, or an adjustable light filter.

64. The platform of claim 59, wherein the processor is positioned in a remote location from that of the light-directing platform.

65. The platform of claim 64, wherein the processor is configured to transmit the reflection modification command via radio signal.

66. The platform of claim 60, wherein the sensor comprises at least one of a wind gauge, a rain gauge, a soil moisture gauge, a stem water potential dendrometer, a pH meter, a gamma-ray sensor, a light gauge, a humidity gauge, a camera, a microphone, a video camera, a chemical sensor, an atmospheric pressure sensor, an O₂ sensor, a N₂ sensor, a CO₂ sensor, a sporadic light sensor, a fruit growth sensor, a reflectance sensor, an infrared sensor, a near-infrared sensor, a fruit density sensor, or a thermometer.

67. The platform of claim 59, wherein the application is further configured for receiving historical data related to the cultivar growing environment from an administrator, and wherein the optimization module further determines the reflective property of the reflective surface based on the historical data.

68. The platform of claim 67, wherein the application further comprises a statistical module configured for receiving the historical data.

69. The platform of claim 60, wherein the growth condition comprises at least one of a wind speed, a wind direction, a rainfall quantity, a soil moisture level, a light intensity, a light angle, a light quality, a relative humidity level, an oxygen level, a carbon dioxide level, a nitrogen level, a chemical level, a soil color, a soil condition, a pest condition, or a temperature.

70. The platform of claim 60, wherein the cultivar parameter comprises at least one of a growth speed, a plant size, a leaf diameter, a plant height, a plant mass, a leaf color, a leaf shape, a plant stem water potential, a plant color, a plant shape, a plant condition, a fruit size, a fruit color, a fruit ripeness, a fruit acidity, a fruit antioxidant content, a fruit sugar content, a fruit density, a foliage density, a stem elongation rate, a reflectance spectra, a fruit density, an acid content, a dry matter content, a root growth rate, a root biomass, a root volume, a root size, a root density, a foliage reflectance spectra, a normalized difference vegetation index, an interior fruit temperature, an exterior fruit temperature, a red reflectance, an infrared reflectance, a near-infrared reflectance, or a fruit yield.

71. The platform of claim 59, wherein the light comprises at least one of a modifiable light, sunlight, UV light, IR light, an electric light, or an LED light.

72. The platform of claim 60, wherein the at least one sensor comprises a plurality of sensors for positioning about the cultivar growing environment.

73. The platform of claim 59, wherein the platform comprises a first sensor configured to sense and/or measure first sensed data corresponding to a cultivar parameter and/or a growth condition and a second sensor configured to sense and/or measure second sensed data corresponding to a growth condition.

74. The platform of claim 73, wherein the optimization module determines the reflection modification command based at least on the first sensed data and the second sensed data.

75. The platform of claim 74, wherein the one or more sensors comprise a plurality of sensors that collectively comprise an internet of things in communication with one another.
